(19) United States
(12) Patent Application Publication
(10) Pub. No.: US 2020/0021837 A1
(43) Pub. Date: Jan. 16, 2020

(54) VIDEO DECODING APPARATUS AND VIDEO CODING APPARATUS

(71) Applicants: SHARP KABUSHIKI KAISHA, Sakai City, Osaka (JP); FG INNOVATION COMPANY LIMITED, Tuen Mun New Territories (CN)

(72) Inventors: TOMOHIRO IKAI, Sakai City, Osaka (JP); YOSHIYA YAMAMOTO, Sakai City, Osaka (JP); NORIO ITOH, Sakai City, Osaka (JP)

(21) Appl. No.: 16/469,367

(22) PCT Filed: Nov. 17, 2017
(86) PCT No.: PCT/JP2017/041474

§ 371 Date: Jun. 13, 2019

(30) Foreign Application Priority Data
Dec. 16, 2016 (JP) 2016-244901

(51) Int. Cl. H04N 19/513; H04N 19/137; H04N 19/46; H04N 19/176

(52) U.S. Cl. CPC H04N 19/513; H04N 19/176; H04N 19/46; H04N 19/137

(57) ABSTRACT

The accuracy of a motion vector is switched based on a picture or a slice. An inter prediction parameter decoding control unit shifts a difference vector by using a shift amount that is identified by a flag for which a value range is configured based on a mode configured for a predetermined region of a reference image including a plurality of prediction blocks.

### TECHNICAL FIELD

The embodiments of the disclosure relate to a video decoding apparatus and a video coding apparatus.

### BACKGROUND ART

A video coding apparatus which generates coded data by coding a video and a video decoding apparatus which generates decoded images by decoding the coded data are used to transmit and record a video efficiently.

Specific video coding schemes include, for example, a scheme proposed by H.264/AVC and High-Efficiency Video Coding (HEVC).

In such a video coding scheme, images (pictures) constituting a video is managed by a hierarchy structure including slices obtained by splitting images, units of coding (also referred to as coding units (CUs)) obtained by splitting slices, prediction units (PUs) which are blocks obtained by splitting coding units, and transform units (TUs), and are coded/decoded for each CU.

In such a video coding scheme, usually, a prediction image is generated based on local decoded images obtained by coding/decoding input images, and prediction residual (also referred to as “difference images” or “residual images”) obtained by subtracting prediction images from input images (original image) are coded. Generation methods of prediction images include an inter-screen prediction (an inter prediction) and an intra-screen prediction (intra prediction).

An example of a technique of recent video coding and decoding is described in NPL 1. NPL 1 discloses a known technology of coding a motion vector based on 4 pixel accuracy in addition to 1 pixel accuracy.

### CITATION LIST

### Non Patent Literature

Non-Patent Document 1: “Enhanced Motion Vector DifferenceCoding”, NET-D0123, JointVideo Exploration Team (JVET) of ITU-T SG 16 WP3 and :ISO/IEC JTC 1/SC 29/WG 11 4th Meeting: Chengdu, CN, 15-21 October 2016

### SUMMARY

### Technical Problem

A motion vector is preferably coded with motion vector accuracy appropriately switched based on the performance of a video coding apparatus or on a picture.

Thus, an aspect of the disclosure is made in view of the above-described goal, and an object of the disclosure is to provide an image decoding apparatus and an image coding apparatus enabling motion vector accuracy to be switched based on the performance of a video coding apparatus, on a picture, or on a slice.

### Solution to Problem

To solve the problem described above, a video decoding apparatus according to one aspect of the disclosure is a video decoding apparatus that generates a prediction image for each prediction block by performing motion compensation on a reference image, and includes a motion vector deriving unit configured to derive a motion vector by adding or subtracting a difference vector to or from a prediction vector for each prediction block, wherein the motion vector deriving unit shifts the difference vector by using a shift amount configured for each of the difference vectors based on an MV signaling mode decoded from coded data in a predetermined region of the reference image including a plurality of the prediction blocks and a motion vector accuracy flag decoded from coded data for the each of the prediction blocks or each of the difference vectors, and derives the motion vector of the prediction block based on a sum of the difference vector shifted and the prediction vector.

A video decoding apparatus according to one aspect of the disclosure is a video decoding apparatus that generates a prediction image for each prediction block by performing motion compensation on a reference image, and includes a motion vector deriving unit configured to derive a motion vector by adding or subtracting a difference vector to or from a prediction vector for each prediction block, wherein the motion vector deriving unit shifts the difference vector by using a shift amount, configured for each of the prediction blocks or each of the difference vectors, that is specified by an MV signaling flag for which a value range is configured based on an MV signaling mode configured in a predetermined region including a plurality of the prediction blocks in the reference image, and derives the motion vector of the prediction block based on a sum of the difference vector shifted and the prediction vector.

A video decoding apparatus according to one aspect of the disclosure is a video decoding apparatus that generates a prediction image for each prediction block by performing motion compensation on a reference image, and includes a motion vector deriving unit configured to derive a motion vector by adding or subtracting a difference vector to or from a prediction vector for each prediction block, wherein the motion vector deriving unit shifts the difference vector for the prediction block by using a shift amount that is configured for a predetermined region of the reference image including a plurality of the prediction blocks and a shift amount configured for each of the prediction blocks, and derives the motion vector of the prediction block based on a sum of the difference vector shifted and the prediction vector.

A video decoding apparatus according to one aspect of the disclosure is a video decoding apparatus that generates a prediction image for each prediction block by performing motion compensation on a reference image, and includes a motion vector deriving unit configured to derive a motion vector by adding or subtracting a difference vector to or from a prediction vector for each prediction block, wherein the motion vector deriving unit shifts the difference vector by using a shift amount corresponding to a size of a resolution of the reference image and a shift amount specified by a flag configured for each of the prediction blocks, and derives the motion vector of the prediction block based on a sum of the difference vector shifted and the prediction vector.

A video decoding apparatus according to one aspect of the disclosure is a video decoding apparatus that generates a prediction image for each prediction block by performing motion compensation on a reference image, and includes a motion vector deriving unit configured to derive a motion vector by adding or subtracting a difference vector to or from a prediction vector for each prediction block, wherein the motion vector deriving unit shifts a horizontal component and a vertical component of the difference vector by using a shift amount corresponding to each direction, and derives the motion vector of the prediction block based on a sum of the difference vector with the horizontal component and the vertical component shifted and the prediction vector.

A video decoding apparatus according to one aspect of the disclosure is a video decoding apparatus that generates a prediction image for each prediction block by performing motion compensation on a reference image, and includes a motion vector deriving unit configured to derive a motion vector by adding or subtracting a difference vector to or from a prediction vector for each prediction block, wherein the motion vector deriving unit shifts the difference vector by using a shift amount corresponding to a position of the prediction block in the reference image, and derives the motion vector of the prediction block based on a sum of the difference vector shifted and the prediction vector.

A video coding apparatus according to one aspect of the disclosure is a video coding apparatus that codes a reference image for each prediction block, and includes a prediction parameter deriving unit configured to code a difference vector for each prediction block, wherein the prediction parameter deriving unit shifts the difference vector by using a shift amount configured for each of the difference vectors based on an MV signaling mode in a predetermined region of the reference image including a plurality of the prediction blocks and a motion vector accuracy flag for each of the prediction blocks or each of the difference vectors.

A video coding apparatus according to one aspect of the disclosure is a video coding apparatus that codes a reference image for each prediction block, and includes a prediction parameter deriving unit configured to code a difference vector for each prediction block, wherein the prediction parameter deriving unit shifts the difference vector for the prediction block by using a shift amount, configured for each of the prediction blocks or each of the difference vectors, that is specified by an MV signaling flag for which a value range is configured based on an MV signaling mode configured in a predetermined region of the reference image including a plurality of the prediction blocks.

A video coding apparatus according to one aspect of the disclosure is a video coding apparatus that codes a reference image for each prediction block, and includes a prediction parameter deriving unit configured to code a difference vector for each prediction block, wherein the prediction parameter deriving unit shifts the difference vector for the prediction block by using a shift amount corresponding to a mode configured in a predetermined region of the reference image including a plurality of the prediction blocks and a shift amount configured for each of the prediction blocks.

A video coding apparatus according to one aspect of the disclosure is a video coding apparatus that codes a reference image for each prediction block, and includes a prediction parameter deriving unit configured to code a difference vector for each prediction block, wherein the prediction parameter deriving unit shifts the difference vector by using a shift amount corresponding to a size of a resolution of the reference image and a shift amount identified by a flag configured for each of the prediction blocks.

A video coding apparatus according to one aspect of the disclosure is a video coding apparatus that codes a reference image for each prediction block, and includes a prediction parameter deriving unit configured to code a difference vector for each prediction block, wherein the prediction parameter deriving unit shifts a horizontal component and a vertical component of the difference vector by using a shift amount corresponding to each direction.

A video coding apparatus according to one aspect of the disclosure is a video coding apparatus that codes a reference image for each prediction block, and includes a prediction parameter deriving unit configured to code a difference vector for each prediction block, wherein the prediction parameter deriving unit shifts the difference vector by using a shift amount corresponding to a position of the prediction block in the reference image.

### Advantageous Effects of Invention

An aspect of the disclosure enables the signaling accuracy of the motion vector to be switched based on the function of the video coding apparatus or a picture.

### BRIEF DESCRIPTION OF DRAWINGS

FIGS. 1A to 1F are diagrams illustrating a hierarchy structure of data of a coding stream according to the present embodiment.

FIGS. 2A to 2H are diagrams illustrating patterns of PU split modes. FIGS. 2A to 2H indicate partition shapes in cases that PU split modes are 2N×2N, 2N×N, 2N×nU, 2N×nD, N×2N, nt×2N, nR×2N, and N×N, respectively.

FIGS. 3A and 3B are conceptual diagrams illustrating an example of reference pictures and reference picture lists.

FIG. 4 is a block diagram illustrating a configuration of an image coding apparatus according to the present embodiment.

FIG. 5 is a schematic diagram illustrating a configuration of an image decoding apparatus according to the present embodiment.

FIG. 6 is a schematic diagram illustrating a configuration of an inter prediction image generation unit of the image coding apparatus according to the present embodiment.

FIG. 7 is a schematic diagram illustrating a configuration of a merge prediction parameter deriving unit according to the present embodiment.

FIG. 8 is a schematic diagram illustrating a configuration of an AMVP prediction parameter deriving unit according to the present embodiment.

FIG. 9 is a flowchart illustrating operations of a motion vector decoding process performed by the image decoding apparatus according to the present embodiment.

FIG. 10 is a schematic diagram illustrating a configuration of an inter prediction parameter coding unit of the image coding apparatus according to the present embodiment.

FIG. 11 is a schematic diagram illustrating a configuration of an inter prediction image generation unit according to the present embodiment.

FIG. 12 is a schematic diagram illustrating a configuration of an inter prediction parameter decoding unit according to the present embodiment.

FIG. 13 is a diagram illustrating an example of a value of signaling accuracy determined from the value of basic vector and the value of shiftS according to the present embodiment.

FIG. 14 is a flowchart illustrating an operation of difference vector decoding processing in the image decoding apparatus according to the present embodiment.

FIGS. 15A and 15B are flowcharts illustrating an operation of motion vector deriving processing in the image decoding apparatus according to the present embodiment.

FIG. 16 is a flowchart illustrating an operation of difference vector deriving processing in the image decoding apparatus according to the present embodiment.

FIG. 17 is a flowchart illustrating an operation of a prediction vector round-processing in the image decoding apparatus according to the present embodiment.

FIG. 18 is a flowchart illustrating an operation of difference vector quantization processing in the image coding apparatus according to the present embodiment.

FIG. 19 is a flowchart illustrating an operation of prediction vector round-processing in the image coding apparatus according to the present embodiment.

FIG. 20 is a flowchart illustrating another operation of the difference vector deriving processing in the image decoding apparatus according to the present embodiment.

FIG. 21 is a diagram illustrating an example of a higher scale addS configured for each slice of a picture according to the present embodiment.

FIG. 22 is a flowchart illustrating another operation of the difference vector deriving processing in the image decoding apparatus according to the present embodiment.

FIG. 23 is a flowchart illustrating an operations of derivation processing for the higher scale addS in the image decoding apparatus according to the present embodiment.

FIG. 24 is a flowchart illustrating an operation of derivation processing for a block scale blockS in the image decoding apparatus according to the present embodiment.

FIG. 25 is a diagram illustrating an example of shiftS and accuracy of a motion vector derived from a picture size and a value indicated by a flag in the image decoding apparatus according to the present embodiment.

FIG. 26 is a diagram illustrating another example of shiftS and the accuracy of the motion vector derived from the picture size and the value indicated by the flag in the image decoding apparatus according to the present embodiment.

FIGS. 27A and 27B are flowcharts illustrating an operation of difference vector deriving processing in the image decoding apparatus according to the present embodiment.

FIGS. 28A and 28B are flowcharts illustrating another operation of the difference vector deriving processing in the image decoding apparatus according to the present embodiment.

FIG. 29 is a flowchart illustrating an operation of deriving processes for blockSVer and blockSHor in the image decoding apparatus according to the present embodiment.

FIGS. 30A and 30B are flowcharts illustrating another operation of the difference vector deriving processing in the image decoding apparatus according to the present embodiment.

FIG. 31 is a flowchart illustrating another operation of the difference vector deriving process in the image decoding apparatus according to the present embodiment.

FIGS. 32A to 32D are diagrams illustrating an example of a target picture frame according to the present embodiment.

FIG. 33 is a diagram illustrating enlargement of an image projected on each surface of a cube according to the present embodiment.

FIGS. 34A and 34B are diagrams illustrating configurations of a transmitting apparatus equipped with the image coding apparatus and a receiving apparatus equipped with the image decoding apparatus according to the present embodiment. FIG. 34A illustrates the transmitting apparatus equipped with the image coding apparatus, and FIG. 34B illustrates the receiving apparatus equipped with the image decoding apparatus.

FIGS. 35A and 35B are diagrams illustrating configurations of a recording apparatus equipped with the image coding apparatus and a regeneration apparatus equipped with the image decoding apparatus according to the present embodiment. FIG. 35A illustrates the recording apparatus equipped with the image coding apparatus, and FIG. 35B illustrates the regeneration apparatus equipped with the image decoding apparatus.

FIG. 36 is a schematic diagram illustrating a configuration of an image transmission system according to the present embodiment.

### DESCRIPTION OF EMBODIMENTS

### First Embodiment

Hereinafter, embodiments of the disclosure are described with reference to the drawings.

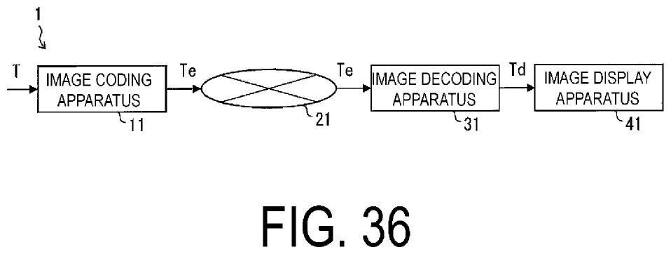

FIG. 36 is a schematic diagram illustrating a configuration of an image transmission system 1 according to the present embodiment.

The image transmission system 1 is a system configured to transmit codes of a coding target image having been coded, decode the transmitted codes, and display an image. The image transmission system 1 is configured to include an image coding apparatus (video coding apparatus) 11, a network 21, an image decoding apparatus (video decoding apparatus) 31, and an image display apparatus 41.

An image T indicating an image of a single layer or multiple layers is input to the image coding apparatus 11. A layer is a concept used to distinguish multiple pictures in a case that there are one or more pictures to configure a certain time. For example, coding an identical picture in multiple layers having different image qualities and resolutions is scalable coding, and coding pictures having different viewpoints in multiple layers is view scalable coding. In a case of performing a prediction (an inter-layer prediction, an inter-view prediction) between pictures in multiple layers, coding efficiency greatly improves. In a case of not performing a prediction, in a case of (simulcast), coded data can be compiled.

The network 21 transmits a coding stream Te generated by the image coding apparatus 11 to the image decoding apparatus 31. The network 21 is the Internet, Wide Area Network (WAN), Local Area Network (LAN), or combinations thereof. The network 21 is not necessarily a bidirectional communication network, but may be a unidirectional communication network configured to transmit broadcast wave such as digital terrestrial television broadcasting and satellite broadcasting. The network 21 may be substituted by a storage medium that records the coding stream Te, such as Digital Versatile Disc (DVD) and Blue-ray Disc (BD).

The image decoding apparatus 31 decodes each of the coding streams Te transmitted by the network 21, and generates one or multiple decoded images Td.

The image display apparatus 41 displays all or part of one or multiple decoded images Td generated by the image decoding apparatus 31. For example, the image display apparatus 41 includes a display device such as a liquid crystal display and an organic Electro-luminescence (EL) display. in spacial scalable coding and SNR scalable coding, in a case that the image decoding apparatus 31 and the image display apparatus 41 have high processing capability, an enhanced layer image having high image quality is displayed, and in a case of having lower processing capability, a base layer image which does not require as high processing capability and display capability as an enhanced layer is displayed.

### Operator

Operators used herein will be described below.

>>is a right bit shift, << is a left bit shift, & is a bitwise AND, | is bitwise OR, and |= is a sum operation (OR) with another condition.

x? y:z is a ternary operator to take y in a case that x is true (other than 0), and take z in a case that x is false (0).

Clip3 (a, b, c) is a function to clip c in a value equal to or greater than a and equal to or less than b, and a function to return a in a case that c is less than a (c<a), return b in a case that c is greater than b (c>b), and return c otherwise (however, a is equal to or less than b (a<=b)).

X̂2 means the square of X. X̂N indicates the N-power of X and is equivalent to X<<log2 (N).

### Structure of Coding Stream Te

Prior to the detailed description of the image coding apparatus 11 and the image decoding apparatus 31 according to the present embodiment, the data structure of the coding stream Te generated by the image coding apparatus 11 and decoded by the image decoding apparatus 31 will be described.

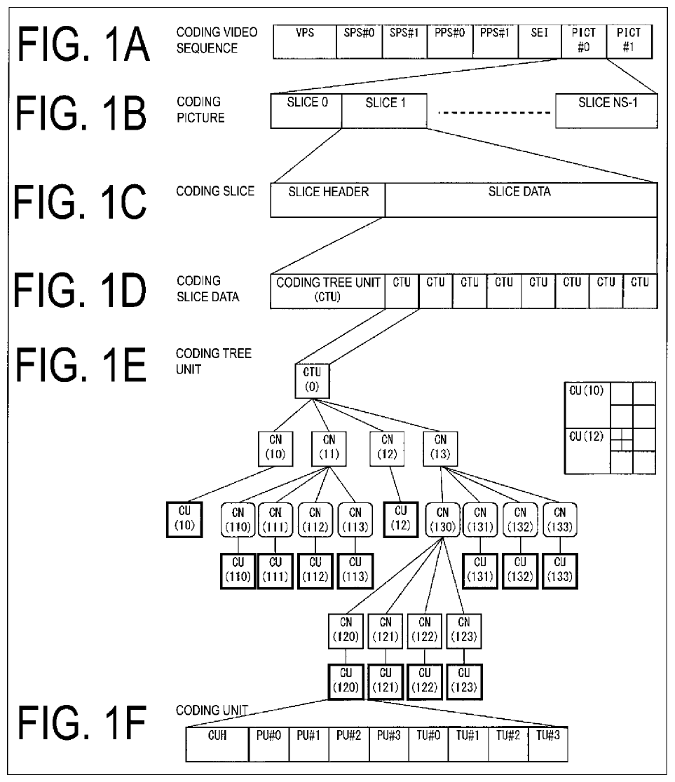

FIGS. 1A to 1F are diagrams illustrating the hierarchy structure of data in the coding stream Te. The coding stream Te includes a sequence and multiple pictures constituting a sequence illustratively. FIGS. 1A to 1F are diagrams indicating a coding video sequence prescribing a sequence SEQ, a coding picture prescribing a picture PICT, a coding slice prescribing a slice S, a coding slice data prescribing slice data, a coding tree unit included in coding slice data, and coding units (CUs) included in a coding tree unit, respectively.

### Coding Video Sequence

In the coding video sequence, a set of data referred to by the image decoding apparatus 31 to decode the sequence SEQ of a processing target is prescribed. As illustrated in FIG. 1A, the sequence SEQ includes a Video Parameter Set, a Sequence Parameter Set SPS, a Picture Parameter Set PPS, a picture PICT, and a Supplemental Enhancement Information SEI. Here, a value indicated after # indicates a layer ID. In FIGS. 1A to 1F, although an example is illustrated where coded data of #0 and #1, in other words, layer 0 and layer 1 exists, types of layers and the number of layers do not depend on this.

In the Video Parameter Set VPS, in a video constituted by multiple layers, a set of coding parameters common to multiple videos and a set of coding parameters associated with multiple layers and an individual layer included in a video are prescribed.

In the Sequence Parameter Set SPS, a set of coding parameters referred to by the image decoding apparatus 31 to decode a target sequence is prescribed. For example, width and height of a picture are prescribed. Note that multiple SPSs may exist. In that case, any of multiple SPSs is selected from the PPS.

In the Picture Parameter Set PPS, a set of coding parameters referred to by the image decoding apparatus 31 to decode each picture in a target sequence is prescribed. For example, a reference value (pic_init_qp_minus26) of a quantization step size used for decoding of a picture and a flag (weighted_pred_flag) indicating an application of a weighted prediction are included. Note that multiple PPSs may exist. In that case, any of multiple PPSs is selected from each picture in a target sequence.

### Coding Picture

In the coding picture, a set of data referred to by the image decoding apparatus 31 to decode the picture PICT of a processing target is prescribed. As illustrated in FIG. 1B, the picture PICT includes slices S0 to S_{NS-1} (NS is the total number of slices included in the picture PICT).

Note that in a case not necessary to distinguish the slices S0 to S_{NS-1} below, subscripts of reference signs may be omitted and described. The same applies to data included in the coding stream are described below and described with an added subscript.

### Coding Slice

In the coding slice, a set of data referred to by the image decoding apparatus 31 to decode the slice S of a processing target is prescribed. As illustrated in FIG. 1C, the slice S includes a slice header SH and a slice data SDATA.

The slice header SH includes a coding parameter group referred to by the image decoding apparatus 31 to determine a decoding method of a target slice. Slice type specification information (slice_type) to specify a slice type is one example of a coding parameter included in the slice header SH.

Examples of slice types that can be specified by the slice type specification information include (1) I slice using only an intra prediction in coding, (2) P slice using a. unidirectional prediction or an intra prediction in coding, and (3) B slice using a unidirectional prediction, a bidirectional prediction, or an intra prediction in coding, and the like.

Note that, the slice header SH may include a reference (pic_parameter_set_id) to the Picture Parameter Set PPS included in the coding video sequence.

### Coding Slice Data

In the coding slice data, a set of data referred to by the image decoding apparatus 31 to decode the slice data SDATA of a processing target is prescribed. As illustrated in FIG. 1D, the slice data SDATA includes Coding Tree Units (CTUs). The CTU is a fixed size (for example, 64×64) block constituting a slice, and may be referred to as a Largest Coding Unit (LCU).

### Coding Tree Unit

As illustrated in FIG. 1E, a set of data referred to by the image decoding apparatus 31 to decode a coding tree unit of a processing target is prescribed. The coding tree unit is split by recursive quad tree splits. Nodes of a tree structure obtained by recursive quad tree splits is referred to as Coding Nodes (CN). Intermediate nodes of quad trees are a coding node, and the coding tree unit itself is also prescribed as the highest layer of coding node. The CTU includes a split flag (cu_split_flag), and is split into four coding node CNs in a case that cu_split_flag is 1. In a case that cu_split_flag is 0, the coding node CN is not split, and has one Coding Unit (CU) as a node. The coding unit CU is an end node of the coding node, and is not split anymore. The coding unit CU is a basic unit of coding processing.

A possible size of the coding unit in a case that a size of the coding tree unit CTU is 64×64 pixels is any of 64×64 pixels, 32×32 pixels, 16×16 pixels, and 8×8 pixels.

### Coding Unit

As illustrated in FIG. 1F, a set of data referred to by the image decoding apparatus 31 to decode the coding unit of a processing target is prescribed. Specifically, the coding unit is constituted by a prediction tree, a transform tree, and a CU header CUH. In the CU header, a prediction mode, a split method (PU split mode), and the like are prescribed.

In the prediction tree, prediction information (a reference picture index, a motion vector, and the like) of each prediction unit (PU) where the coding unit is split into one or multiple is prescribed. In another expression, the prediction unit is one or multiple non-overlapping regions constituting the coding unit. The prediction tree includes one or multiple prediction units obtained by the above-mentioned split. Note that, in the following, a unit of prediction where the prediction unit is further split is referred to as a “subblock”. The subblock is constituted by multiple pixels. In a case that sizes of the prediction unit and the subblock is same, there is one subblock in the prediction unit. In a case that the prediction unit is larger than a size of the subblock, the prediction unit is split into subblocks. For example, in a case that the prediction unit is 8×8, and the subblock is 4×4, the prediction unit is split into four subblocks formed by two horizontal splits and two perpendicular splits.

The prediction processing may be performed for each of these prediction units (subblocks).

Generally speaking, there are two types of split in the prediction tree including a case of an intra prediction and a case of an inter prediction. The intra prediction is a prediction in an identical picture, and the inter prediction refers to a prediction processing performed between mutually different pictures (for example, between display times, and between layer images).

In a case of an intra prediction, the split method has 2N×2N (the same size as the coding unit) and N×N.

In a case of an inter prediction, the split method includes coding by a PU split mode (part mode) of the coded data, and includes 2N×2N (the same size as the coding unit), 2N×N, 2N×nU, 2N×nD, N×2N, nL×2N, nR×2N and N×N, and the like. Note that 2N×N and N×2N indicate a symmetric split of 1:1, and 2N×nU, 2N×nD and nL×2N, nR×2N indicate an asymmetry split of 1:3 and 3:1. The PUs included in the CU are expressed as PU0, PU1, PU2, and PU3 sequentially.

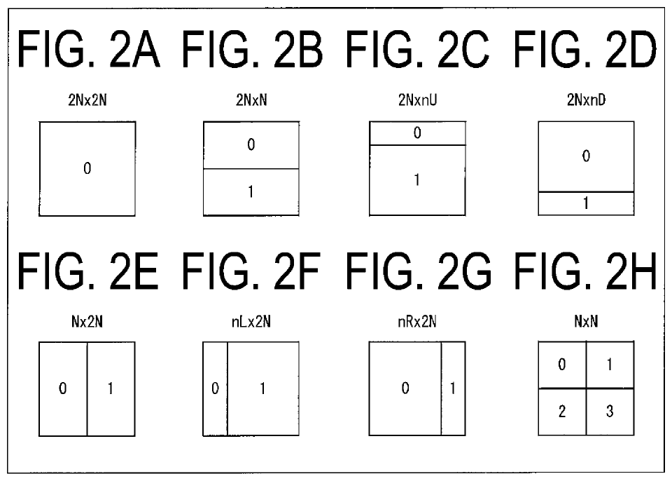

FIGS. 2A to 2H illustrate shapes of partitions in respective PU split modes (positions of boundaries of PU splits) specifically. FIG. 2A indicates a partition of 2N×2N, and FIGS, 2B, 2C, and 2D indicate partitions (horizontally long partitions) of 2N×N, 2N×nU, and 2N×nD, respectively. FIGS. 2E, 2F, and 2G indicate partitions (vertically long partitions) in cases of N×2N, nL×2N, and nR×2N, respectively, and FIG. 2H indicates a partition of N×N. Note that horizontally long partitions and vertically long partitions are collectively referred to as rectangular partitions, and 2N×2N and N×N are collectively referred to as square partitions.

In the transform tree, the coding unit is split into one or multiple transform units, and a position and a size of each transform unit are prescribed. In another expression, the transform unit is one or multiple non-overlapping regions constituting the coding unit. The transform tree includes one or multiple transform units obtained by the above-mentioned split.

Splits in the transform tree include those to allocate a region that is the same size as the coding unit as a transform unit, and those by recursive quad tree partitioning similar to the above-mentioned splits of CUs.

A transform processing is performed for each of these transform units.

### Prediction Parameter

A prediction image of Prediction Units (PUs) is derived by prediction parameters attached to the PUs. The prediction parameter includes a prediction parameter of an intra prediction or a prediction parameter of an inter prediction. The prediction parameter of an inter prediction (inter prediction parameters) will be described below. The inter prediction parameter is constituted by prediction list utilization flags predFlagL0 and predFlagL1,reference picture indexes refId×L0 and refId×L1, and motion vectors mvL0 and mvL1. The prediction list utilization flags predFlagL0 and predFlagL1 are flags to indicate whether or not reference picture lists referred to as L0 list and L1 list respectively are used, and a corresponding reference picture list is used in a case that the value is 1. Note that, in a case that the present specification mentions “a flag indicating whether or not XX”, a flag being other than 0 (for example, 1) assumes a case of XX, and a flag being 0 assumes a case of not XX, and 1 is treated as true and 0 is treated as false in a logical negation, a logical product, and the like (hereinafter, the same is applied). However, other values can be used for true values and false values in real apparatuses and methods.

For example, syntax elements to derive inter prediction parameters included in a coded data include a PU split mode part_mode, a merge flag merge_flag, a merge index merge_idx, an inter prediction indicator interprek_idc, a reference picture index refldxLX, a prediction vector index mvp_LX_idx, and a difference vector mvdLX.

### Reference Picture List

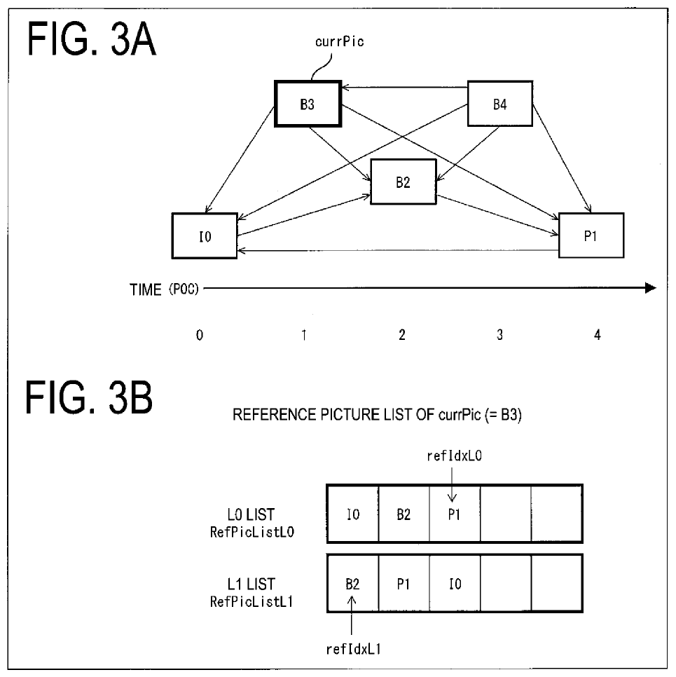

A reference picture list is a list constituted by reference pictures stored in a reference picture memory 306. FIGS. 3A and 3B are conceptual diagrams illustrating an example of reference pictures and reference picture lists. In FIG. 3A, a rectangle indicates a picture, an arrow indicates a reference relationship of a picture, a horizontal axis indicates time, each of I, P, and B in a rectangle indicates an intra-picture, a uni-prediction picture, a bi-prediction picture, and a number in a rectangle indicates a decoding order. As illustrated, the decoding order of the pictures is I0, P1, B2, B3, and B4, and the display order is I0, B3, B2, B4, and P1. FIG. 3B indicates an example of reference picture lists. The reference picture list is a list to represent a candidate of a reference picture, and one picture (slice) may include one or more reference picture lists. in the illustrated example, a target picture B3 includes two reference picture lists, i.e., a L0 list RefPicList0 and a L1 list RefPicList1. In a case that a target picture is B3, the reference pictures are I0, P1, and B2, the reference picture includes these pictures as elements. For an individual prediction unit, which picture in a reference picture list RefPicListX is actually referred to is specified with a reference picture index refId×LX. The diagram indicates an example where reference pictures P1 and B2 are referred to by refId×L0 and refId×L1.

### Merge Prediction and AMVP Prediction

Decoding (coding) methods of prediction parameters include a merge prediction (merge) mode and an Adaptive Motion Vector Prediction (AMVP) mode, and merge flag merge_flag is a flag to identify these. The merge prediction mode is a mode to use to derive from prediction parameters of neighboring PUs already processed without including a prediction list utilization flag predFlag.LX (or an inter prediction indicator inter_pred_idc), a reference picture index refId×LX, and a motion vector mvLX in a coded data, and the AMVP mode is a mode to include an inter prediction indicator inter_pred_idc, a reference picture index refId×LX, a motion vector mvLX in a coded data. Note that, the motion vector mvLX is coded as a prediction vector index mvp_LX_idx identifying a prediction vector mvpLX and a difference vector mvdLX.

The inter prediction indicator inter_pred_idc is a value indicating the types and the number of reference pictures, and takes any value of PRED_L0, PRED_L1, and PRED_B1. PRED_L0 and PRED_L1 indicate to uses reference pictures managed in the reference picture list of the L0 list and the L1 list respectively, and indicate to use one reference picture (uni-prediction). PRED_B1 indicates to use two reference pictures (bi-prediction BiPred), and use reference pictures managed in the L0 list and the L1 list. The prediction vector index mvp_LX_idx is an index indicating a prediction vector, and the reference picture index refIdxLX is an index indicating reference pictures managed in a reference picture list. Note that LX is a description method used in a case of not distinguishing the L0 prediction and the L1 prediction, and distinguishes parameters for the L0 list and parameters for the L1 list by replacing LX with L0 and L1.

The merge index merge_idx is an index to indicate to use either prediction parameter as a prediction parameter of a decoding target PU among prediction parameter candidates (merge candidates) derived from PUs of which the processing is completed.

### Motion Vector

The motion vector mvLX indicates a gap quantity between blocks in two different pictures. A prediction vector and a difference vector related to the motion vector mvLX is referred to as a prediction vector mvpLX and a difference vector mvdLX respectively.

Inter Prediction indicator inter_pred_idc and Prediction List Utilization Flag predFlagLX

A relationship between an inter prediction indicator inter_pred_idc and prediction list utilization flags predFlagL0 and predFlagL1 are as follows, and those can be converted mutually.

inter_pred_idc=(predFlagL1<<1)+predFlagL0

predFlagL0=inter_pred_idc & 1

predFlagL1=inter_pred_idc>>1

Note that an inter prediction parameter may use a prediction list utilization flag or may use an inter prediction indicator. A determination using a prediction list utilization flag may be replaced with a determination using an inter prediction indicator. On the contrary, a determination using an inter prediction indicator may be replaced with a determination using a prediction list utilization flag.

Determination of Bi-Prediction biPred

A flag biPred of whether or not a bi-prediction BiPred can be derived from whether or not two prediction list utilization flags are both 1. For example, the flag can be derived by the following equation.

biPred=(predFlagL0==1&&predFlagL1==1)

The flag biPred can be also derived from whether an inter prediction indicator is a value indicating to use two prediction lists (reference pictures). For example, the flag can be derived by the following equation.

biPred=(inter_pred_idc==PRED_BI)?1:0

The equation can be also expressed with the following equation.

biPred=(inter_pred_idc==PRED_BI)

Note that, for example, PRED_BI can use the value of 3.

### Configuration of Image Decoding Apparatus

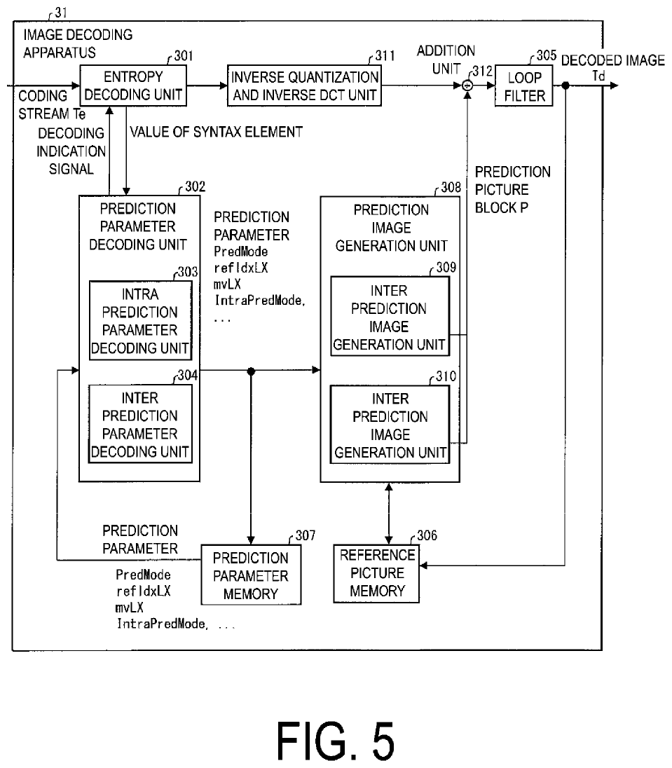

A configuration of the image decoding apparatus 31 according to the present embodiment will now be described. FIG. 5 is a schematic diagram illustrating a configuration of the image decoding apparatus 31 according to the present embodiment. The image decoding apparatus 31 is configured to include an entropy decoding unit 301, a prediction parameter decoding unit (a prediction image decoding apparatus) 302, a loop filter 305, a reference picture memory 306, a prediction parameter memory 307, a prediction image generation unit (prediction image generation apparatus) 308, a dequantization and inverse DCT unit 311, and an addition unit 312.

The prediction parameter decoding unit 302 is configured to include an inter prediction parameter decoding unit 303 and an intra prediction parameter decoding unit 304. The prediction image generation unit 308 is configured to include an inter prediction image generation unit 309 and an intra prediction image generation unit 310.

The entropy decoding unit 301 performs entropy decoding on the coding stream Te input from the outside, and separates and decodes individual codes (syntax elements). Separated codes include prediction information to generate a prediction image and residual information to generate a difference image and the like.

The entropy decoding unit 301 outputs a part of the separated codes to the prediction parameter decoding unit 302. For example, a part of the separated codes includes a prediction mode predMode, a PU split mode part_mode, a merge flag merge_flag, a merge index merge_idx, an inter prediction indicator inter_pred_idc, a reference picture index refIdxLX, a prediction vector index mvp_LX_idx, and a difference vector mvdLX. The control of which code to decode is performed based on an indication of the prediction parameter decoding unit 302. The entropy decoding unit 301 outputs quantization coefficients to the dequantization and inverse DCT unit 311. These quantization coefficients are coefficients obtained by performing Discrete Cosine Transform (DCT) on residual signal to quantize in the coding process.

The inter prediction parameter decoding unit 303 decodes an inter prediction parameter with reference to a prediction parameter stored in the prediction parameter memory 307 based on a code input from the entropy decoding unit 301.

The inter prediction parameter decoding unit 303 outputs a decoded inter prediction parameter to the prediction image generation unit 308, and also stores the decoded inter prediction parameter in the prediction parameter memory 307. Details of the inter prediction parameter decoding unit 303 will be described below.

The intra prediction parameter decoding unit 304 decodes an intra prediction parameter with reference to a prediction parameter stored in the prediction parameter memory 307 based on a code input from the entropy decoding unit 301. The intra prediction parameter is a parameter used in a processing to predict a CU in one picture, for example, an intra prediction mode IntraPredMode. The intra prediction parameter decoding unit 304 outputs a decoded intra prediction parameter to the prediction image generation unit 308, and also stores the decoded intra prediction parameter in the prediction parameter memory 307.

The intra prediction parameter decoding unit 304 may derive different intra prediction modes for luminance and chrominance. In this case, the intra prediction parameter decoding unit 304 decodes a luminance prediction mode IntraPredModeY as a prediction parameter of luminance, and decodes a chrominance prediction mode IntraPredModeC as a prediction parameter of chrominance. The luminance prediction mode IntraPredModeY includes 35 modes, and corresponds to a planar prediction (0), a DC prediction (1), directional predictions (2 to 34). The chrominance prediction mode IntraPredModeC uses any of a planar prediction (0), a DC prediction (1), directional predictions (2 to 34), and a LM mode (35). The intra prediction parameter decoding unit 304 may decode a flag indicating whether IntraPredModeC is a mode same as the luminance mode, assign IntraPredModeY to IntraPredModeC in a case of indicating that the flag is the mode same as the luminance mode, and decode a planar prediction (0), a DC prediction (1), directional predictions (2 to 34), and a LM mode (35) as IntraPredModeC in a case of indicating that the flag is a mode different from the luminance mode.

The loop filter 305 applies a filter such as a deblocking filter, a sample adaptive offset (SAO), and an adaptive loop filter (ALF) on a decoded image of a CU generated by the addition unit 312.

The reference picture memory 306 stores a decoded image of a CU generated by the addition unit 312 in a prescribed position for each picture and CU of a decoding target.

The prediction parameter memory 307 stores a prediction parameter in a prescribed position for each picture and prediction unit (or a subblock, a fixed size block, and a pixel) of a decoding target. Specifically, the prediction parameter memory 307 stores an inter prediction parameter decoded by the inter prediction parameter decoding unit 303, an intra prediction parameter decoded by the intra prediction parameter decoding unit 304 and a prediction mode predMode separated by the entropy decoding unit 301. For example, inter prediction parameters stored include a prediction list utilization flag predFlagLX (the inter prediction indicator inter_pred_idc), a reference picture index refIdxLX, and a motion vector mvLX.

To the prediction image generation unit 308, a prediction mode predMode input from the entropy decoding unit 301 is input, and a prediction parameter is input from the prediction parameter decoding unit 302. The prediction image generation unit 308 reads a reference picture from the reference picture memory 306. The prediction image generation unit 308 generates a prediction image of a PU using a prediction parameter input and a reference picture read with a prediction mode indicated by the prediction mode predMode.

Here, in a case that the prediction mode predMode indicates an inter prediction mode, the inter prediction image generation unit 309 generates a prediction image of a PU by an inter prediction using an inter prediction parameter input from the inter prediction parameter decoding unit 303 and a read reference picture.

For a reference picture list (a L0 list or a L1 list) where a prediction list utilization flag predFlagLX is 1, the inter prediction image generation unit 309 reads a reference picture block from the reference picture memory 306 in a position indicated by a motion vector mvLX, based on a decoding target PU from reference pictures indicated by the reference picture index refIdxLX. The inter prediction image generation unit 309 performs a prediction based on a read reference picture block and generates a prediction image of a PU. The inter prediction image generation unit 309 outputs the generated prediction image of the PU to the addition unit 312.

In a case that the prediction mode predMode indicates an intra prediction mode, the intra prediction image generation unit 310 performs an intra prediction using an intra prediction parameter input from the intra prediction parameter decoding unit 304 and a read reference picture. Specifically, the intra prediction image generation unit 310 reads an adjacent PU, which is a picture of a decoding target, in a prescribed range from a decoding target PU among PUs already decoded, from the reference picture memory 306. The prescribed range is, for example, any of adjacent PUs of in left, top left, top, and top right in a case that a decoding target PU moves in order of so-called raster scan sequentially, and varies according to intra prediction modes. The order of the raster scan is an order to move sequentially from the left edge to the right edge in each picture for each row from the top edge to the bottom edge.

The intra prediction image generation unit 310 performs a prediction in a prediction mode indicated by the intra prediction mode IntraPredMode for a read adjacent PU, and generates a prediction image of a PU. The intra prediction image generation unit 310 outputs the generated prediction image of the PU to the addition unit 312.

In a case that the intra prediction parameter decoding unit 304 derives different intra prediction modes with luminance and chrominance, the intra prediction image generation unit 310 generates a prediction image of a PU of luminance by any of a planar prediction (0), a DC prediction (1), and directional predictions (2 to 34) depending on a luminance prediction mode IntraPredModeY, and generates a prediction image of a PU of chrominance by any of a planar prediction (0), a DC prediction (1), directional predictions (2 to 34), and LM mode (35) depending on a chrominance prediction mode IntraPredModeC.

The dequantization and inverse DCT unit 311 dequantizes quantization coefficients input from the entropy decoding unit 301 and calculates DCT coefficients. The dequantization and inverse DCT unit 311 performs an Inverse Discrete Cosine Transform (an inverse DCT, an inverse discrete cosine transform) for the calculated DCT coefficients, and calculates a residual signal. The dequantization and inverse DCT unit 311 outputs the calculated residual signal to the addition unit 312.

The addition unit 312 adds a prediction image of a PU input from the inter prediction image generation unit 309 or the intra prediction image generation unit 310 and a residual signal input from the dequantization and inverse DCT unit 311 for every pixel, and generates a decoded image of a PU. The addition unit 312 stores the generated decoded image of a PU in the reference picture memory 306, and outputs a decoded image Td where the generated decoded image of the PU is integrated for every picture to the outside.

### Configuration of Inter Prediction Parameter Decoding Unit

Next, a configuration of the inter prediction parameter decoding unit 303 will be described.

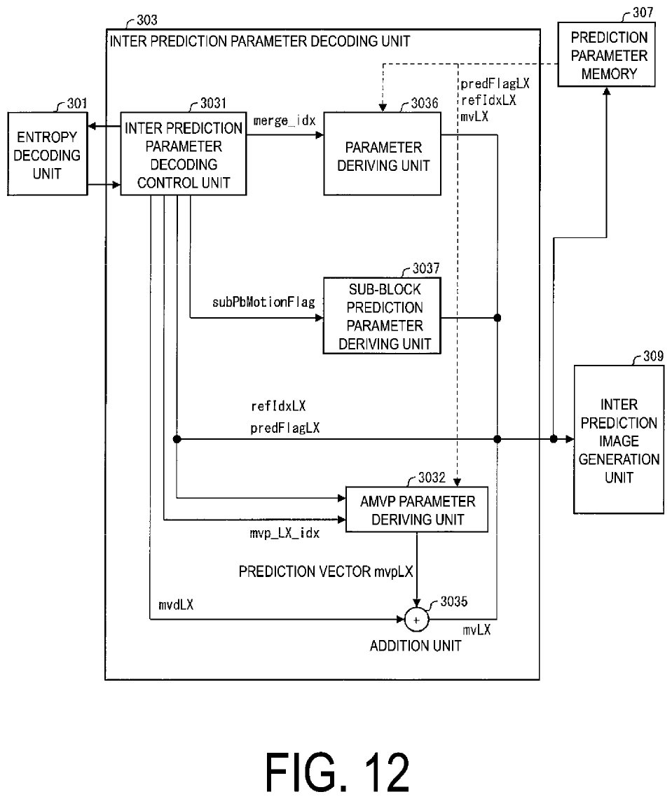

FIG. 12 is a schematic diagram illustrating a configuration of the inter prediction parameter decoding unit 303 according to the present embodiment. The inter prediction parameter decoding unit 303 includes an inter prediction parameter decoding control unit 3031, an AMVP prediction parameter deriving unit 3032, an addition unit 3035, a merge prediction parameter deriving unit 3036, and a sub-block prediction parameter deriving unit 3037.

The inter prediction parameter decoding control unit 3031 instructs the entropy decoding unit 301 to decode a code (syntax element) related to inter prediction, to extract a PU split mode part_mode, a merge flag merge_flag, a merge index merge_idx, an inter prediction indicator inter_pred_idc, a reference picture index refldxLX, a prediction vector index mvp_LX_idx, and a difference vector mvdLX, for example.

The inter prediction parameter decoding control unit 3031 first extracts the merging flag merge_flag. The expression indicating that the inter prediction parameter decoding control unit 3031 extracts a certain syntax element means that the inter prediction parameter decoding control unit 3031 instructs the entropy decoding unit 301 to decode the certain syntax element and reads the syntax element is read from the coded data.

In a case that the merging flag merge_flag indicates 0, that is, AMVP prediction mode, the inter prediction parameter decoding control unit 3031 extracts the AM VP prediction parameter from the coded data using the entropy decoding unit 301. Examples of the AMVP prediction parameter include an inter prediction identifier inter_pred_idc, a reference picture index refIdxLx, prediction vector index mvp_LX_idx, and a difference vector mvdLX. AM VP prediction parameter deriving unit 3032 derives the prediction vector mvpLX from the prediction vector index mvp_LX_idx. Details will be described below. The inter prediction parameter decoding control unit 3031 outputs a difference vector mvdLX to the addition unit 3035. In the addition unit 3035, the prediction vector mvpLX and the difference vector mvdLX are added together, and a motion vector is derived.

In a case that the merging flag merge_flag indicates one, i.e., the merging prediction mode, the inter prediction parameter decoding control unit 3031 extracts the merging index merge_idx as a prediction parameter related to the merging prediction. The inter prediction parameter decoding control unit 3031 outputs the extracted merging index merge_idx to the merging prediction parameter deriving unit 3036 (details will be described later), and outputs the sub-block prediction mode flag subPbMotionFlag to the sub-block prediction parameter deriving unit 3037. The sub-block prediction parameter deriving unit 3037 divides PU into a plurality of sub-blocks in accordance with the value of the sub-block prediction mode flag subPbMotionFlag, and derives the motion vector in sub-block units. In other words, in the sub-block prediction mode, the prediction block is predicted in units of small blocks of 4×4 or 8×8. In the image coding apparatus 11 described below, CU is divided into a plurality of partitions (PU, such as 2N×N, N×2N, N×N, etc.) and code the syntax of the prediction parameter in partition units. In the sub-block prediction mode, multiple sub-blocks are grouped (set), and the syntax of the prediction parameters is coded for each of the sets, so that motion information of many sub-blocks can be coded with a small number of coding amounts.

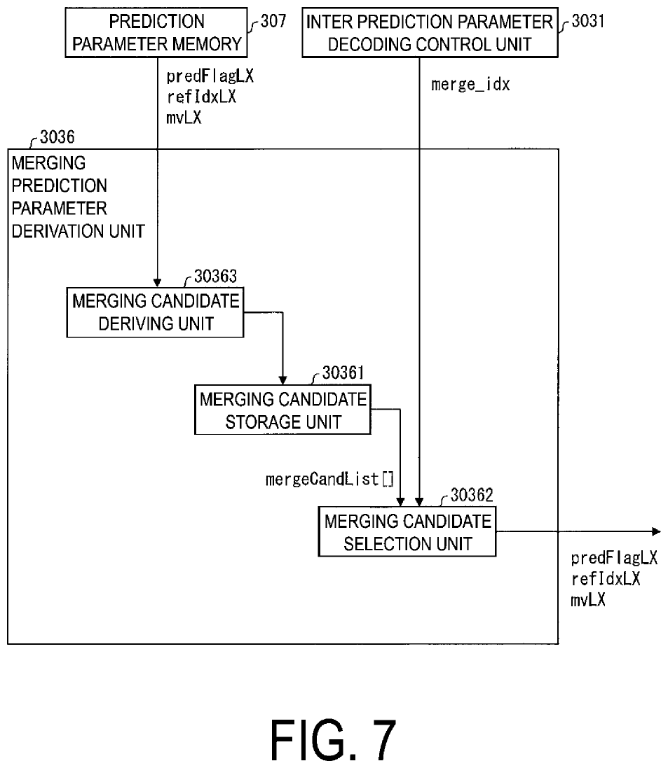

FIG. 7 is a schematic diagram illustrating a configuration of a merging prediction parameter deriving unit 3036 according to the present embodiment. The merging prediction parameter deriving unit 3036 includes a merging candidate deriving unit 30361, a merging candidate selection unit 30362, and a merging candidate storage unit 30363. The merging candidate storage unit 30363 stores a merging candidate input from the merging candidate deriving unit 30361. Note that the merging candidate is configured to include a prediction list use flag predFlagLX, a motion vector mvLX, and a reference picture index refIdxLX. The merging candidates stored in the merging candidate storage unit 30363 are each assigned an index based on a predetermined rule.

The merging candidate deriving unit 30361 derives the merging candidate by directly using the motion vector and the reference picture index refldxLX of the adjacent PU for which decoding has already been performed. Alternatively, an affine prediction may be used to derive the merging candidate. This method is described in detail below. The merging candidate deriving unit 30361 may use the affine prediction in spatial merging candidate deriving processing, time merging candidate deriving process, combined merging candidate deriving processing, and zero merging candidate deriving processing described later. Note that the affine prediction is performed in sub-block units, and the prediction parameter is stored in the prediction parameter memory 307 for each sub-block. Alternatively, the affine prediction may be performed in units of pixels.

### Spatial Merging Candidate Deriving Process

As spatial merging candidate derivation processing, the merging candidate deriving unit 30361 reads a prediction parameter (prediction list use flag predFlagLX, motion vector mvLX, and reference picture index refIdxLX) stored in the prediction parameter memory 307 based on a predetermined rule, and derives the read prediction parameter as a merging candidate. The prediction parameter thus read is a prediction parameter related to each of PUs (e.g., some or all of PUs in contact with the left lower end, the left upper end, and the right upper end of the PU to he decoded) within a predetermined range from the PU to be decoded. The merging candidate derived by the merging candidate deriving unit 30361 is stored in the merging candidate storage unit 30363.

### Time Merging Candidate Deriving Processing

As the time merging derivation processing, the merging candidate deriving unit 30361 reads, as the merging candidate, a prediction parameter of a PU in the reference image including the lower right coordinates of the decoding target PU. The reference image may be specified as follows for example. Specifically, a reference picture index refIdxLX specified in the slice header, or the smallest one of reference picture indices refIdxLX of PUs adjacent to the decoding subject PU may be used for specifying the image. The merging candidate derived by the merging candidate deriving unit 30361 is stored in the merging candidate storage unit 30363.

### Combined Merging Candidate Deriving Processing

As the combined merging deriving processing, the merging candidate deriving unit 30361 derives a combined merging candidate by combining the motion vectors and the reference picture indices of two different merging candidates that have been derived and stored in the merging candidate storage 30363 as respective motion vectors of L0 and L1. The merging candidate derived by the merging candidate deriving unit 30361 is stored in the merging candidate storage unit 30363.

### Zero Merging Candidate Deriving Processing

As the zero merging candidate deriving processing, the merging candidate deriving unit 30361 derives a merging candidate having a reference picture index refIdxLX of 0, and having a motion vector mvLX with the X component and the Y component that are both 0. The merging candidate derived by the merging candidate deriving unit 30361 is stored in the merging candidate storage unit 30363.

The merging candidate selection unit 30362 selects, from the merging candidates stored in the merging candidate storage unit 30363, the merging candidate assigned with an index corresponding to the merging index merge_idx input from the inter prediction parameter decoding control unit 3031, as the inter prediction parameter of the target PU. The merging candidate selection unit 30362 stores the selected merging candidate in the prediction parameter memory 307 and outputs the selected merging candidate to the prediction image generation unit 308.

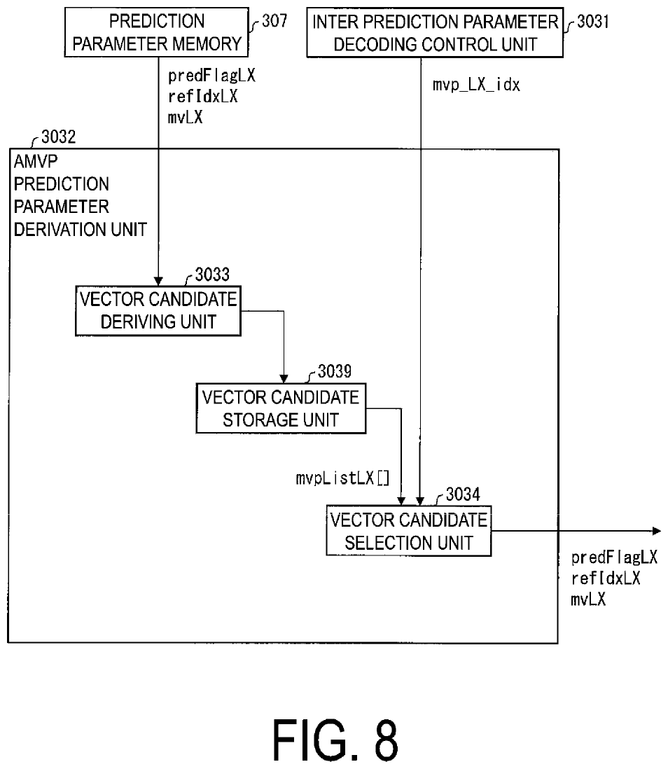

FIG. 8 is a schematic diagram illustrating a configuration of the AMVP prediction parameter deriving unit 3032 according to the present embodiment. The AMVP prediction parameter deriving unit 3032 includes a vector candidate deriving unit 3033, a vector candidate selection unit 3034, and a vector candidate storage unit 3039. The vector candidate deriving unit 3033 reads out the motion vector mvLX of the already processed PU stored in the prediction parameter memory 307 based on the reference picture index refIdx, derives the prediction vector candidate, and stores the prediction vector candidate in a prediction vector candidate list mvpListLX. of the vector candidate storage unit 3039.

The vector candidate selection unit 3034 selects a motion vector mvpListLX [mvp_LX_idx] from the prediction vector candidates in the prediction vector candidate list mvpListLX [ ], as the prediction vector mvpLX. The vector candidate selection unit 3034 outputs the selected prediction vector mvpLX to the addition unit 3035.

Note that the prediction vector candidate is derived by scaling a motion vector of a PU (e.g., adjacent PU), on which the decoding processing has already been completed, in a predetermined range from the PU to be decoded PU. Note that the adjacent PU includes PUs spatially adjacent to the decoding target PU (PUs on the left and the upper sides) and also includes a region temporally adjacent to the decoding target PU (a region obtained from a prediction parameter of a PU having the same position as the decoding target PU but is different from the decoding target PU in the display timing).

The addition unit 3035 calculates the motion vector mvLX by adding the prediction vector mvpLX input from the AMVP prediction parameter deriving unit 3032 with the difference vector mvdLX input from the inter prediction parameter decoding control unit 3031. The addition unit 3035 outputs the calculated motion vector mvLX to the prediction image generation unit 308 and the prediction parameter memory 307.

### Inter Prediction Image Generation Unit 309

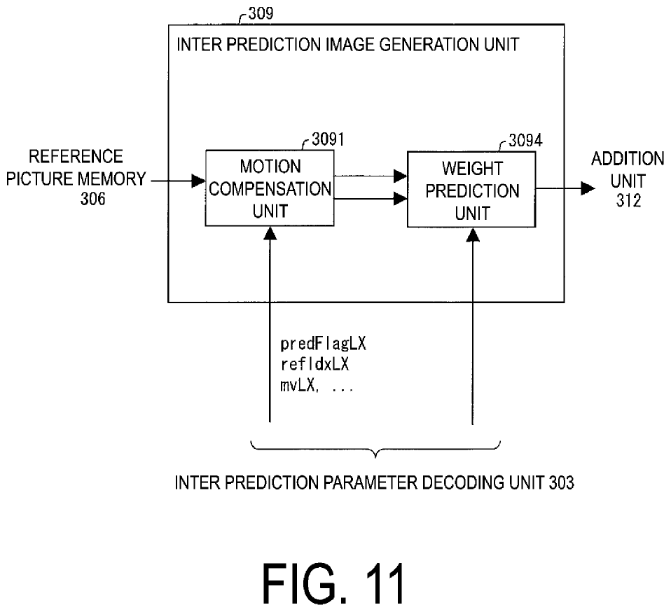

FIG. 11 is a schematic diagram illustrating a configuration of the inter prediction image generation unit 309 included in the prediction image generation unit 308 according to the present embodiment. The inter prediction image generation unit 309 is configured to include a motion compensation unit (prediction image generation apparatus)3091 and a weight prediction unit 3094.

### Motion Compensation

The motion compensation unit 3091 generates an interpolation image (motion interpolation image) by reading a block at a position shifted from the position of the decoding target PU by the motion vector mvLX in a reference picture, in the reference picture memory 306, indicated with the reference picture index refIdxLX, based on the inter prediction parameter (prediction list use flag predFlagLX, reference picture index refIdxLX, motion vector mvLX) input from the inter prediction parameter decoding unit 303. Here, in a case that the accuracy of the motion vector mvLX is not an integer accuracy, a filter known as a motion compensation filter for generating pixels at decimal positions, to generate a motion compensation image.

### Weight Prediction

The weight prediction unit 3094 generates a PU prediction image by multiplying the input motion compensation image predSamplesLX by a weighting factor. In a case that one of the prediction list usage flags (predFlagL0 or predFlagL1) is 1 (in a case of uni-prediction) and no weighting prediction is used, processing according to the following formula is performed so that the input motion compensation image predSamplesLX (LX is L0 or L1) conforms to the number of pixel bits bitDepth.

PredSamples [X] [Y]=Clip3 (0, (1<<bitDepth)−1, (predSamplesLX [X] [Y]+offset1)>>shift1)

Here, shift1=14−bitDepth, offset1=1<<(shift1-1) holds true.

In a case that both of the reference list usage flags (predFlagL0 and predFlagL1) are 1 (in a case of bi-prediction BiPred) and no weighting prediction is used, the processing according to the following formula is performed so that the input motion compensation images predSamplesL0 and predSamplesL1 are averaged to conform to the number of pixel bits.

PredSamples [X] [Y]=Clip3 (0, (1<<bitDepth)−1, predSamplesL0 [X] [Y]+predSamplesL1 [X] [Y]+offset2)>>shift2)

Here, shift2=15−bitDepth, offset2=1<<(shift2-1) holds true.

Furthermore, in a case of uni-prediction with the weighting prediction performed, the weight prediction unit 3094 derives a weighting prediction coefficient w0 and an offset o0 from coded data, and performs processing according to the following formula.

PredSamples [X] [Y]=Clip3 (0, (1<<bitDepth)−1, (predSamplesLX [X] [Y]*w0+2̂(log2WD−1))>>log2WD)+o0)

Here, log2WD is a variable indicating a predetermined shift amount

Furthermore, in a case of bi-prediction BiPred with the weighting prediction performed, the weight prediction unit 3094 derives weighting prediction coefficients w0, w1, o0, and o1 from coded data, and performs processing according to the following formula.

PredSamples [X] [Y] Clip3 (0, (1<<bitDepth)−1, (predSamplesL0 [X] w0+predSamplesL1 [X] [Y]*w1 ((o0+o1+1)<<log2WD))>log2WD+1)

### Motion Vector Decoding Processing

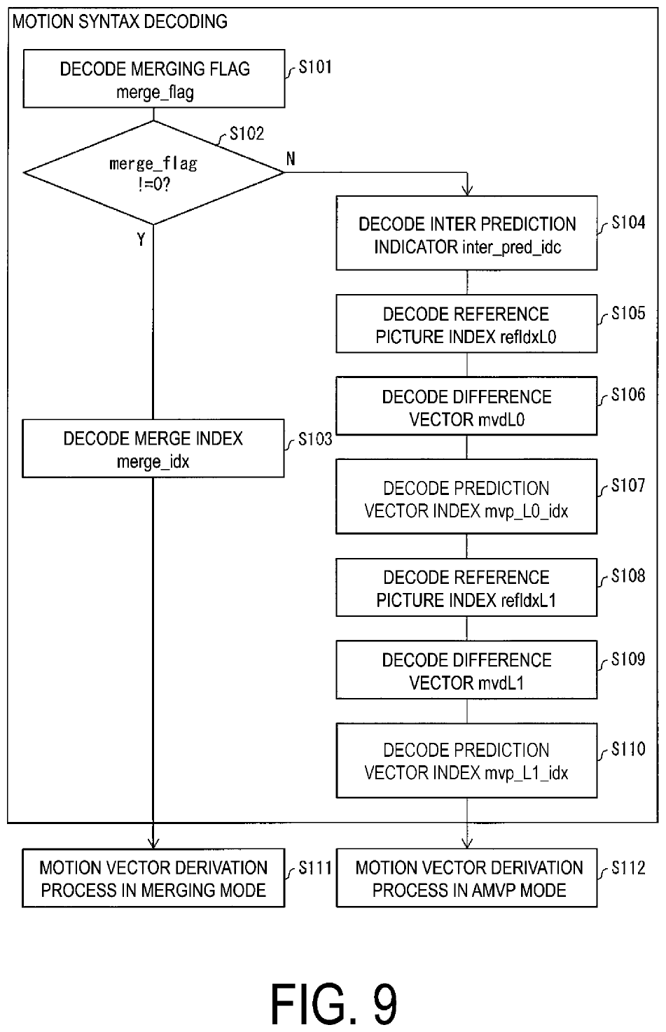

Motion vector decoding processing according to the present embodiment will be described in detail below with reference to FIG. 9.

As is clear from the description above, the motion vector decoding processing according to the present embodiment includes processing for decoding a syntax element related to inter prediction (also referred to as motion syntax decoding processing), and processing for deriving a motion vector (motion vector deriving processing).

### Motion Syntax Decoding Process

FIG. 9 is a flowchart illustrating a flow of the inter prediction syntax decoding processing performed by the inter prediction parameter decoding control unit 3031. In the following description with reference to FIG. 9, each process is performed by the inter prediction parameter decoding control unit 3031 unless clearly stated otherwise.

First, in step S101, the merging flag merge_flag is decoded, and in step S102. whether merge_flag!=0 (merge_flag not 0) hold true is determined.

In a case that merge_flag!=0 holds true (S102 Y), the merging index merge_idx is decoded in S103, and motion vector deriving processing in a merging mode is performed (S111).

In a case that merge_flag!=0 does not hold true (N at S102), the inter prediction identifier inter_pred_idc is decoded in S104.

In a case that inter pred_idc is other than PRED_L1 (PRED_L0 or PRED_B1), the reference picture index refldxL0, the difference vector parameter mvdL0, and the prediction vector index mvp_L0_idx are decoded in S105, S106, and S107, respectively.

In a case that inter pred idc is other than PRED_L0 (PRED_L1 or PRED_B1), the reference picture index refIdxL1, the difference vector parameter mvdL1, and the prediction vector index mvp_L1_idx are decoded in S108, S109, and S110. Subsequently, motion vector deriving processing in an AMVP mode is performed (S112).

### Motion Vector Accuracy Switching

Here, motion vector accuracy switching will be described. A motion vector is expressed in units of a basic vector accuracy (¼ pixel accuracy for example) that is an accuracy of a motion vector stored in the prediction parameter memory 307, a motion vector input and output to and from the motion compensation unit 3091, and a motion vector used for the affine transformation (affine prediction), and the like. On the other hand, the image coding apparatus 11 may code the motion vector with an accuracy (signaling accuracy) that is lower than the above-described basic vector accuracy, and transmit the coded motion vector to the image decoding apparatus 31.

Thus, the image coding apparatus 11 may convert (quantize) the accuracy of the motion vector from the basic vector accuracy to the signaling accuracy, and transmit the motion vector to the image decoding apparatus 31. For example, the image coding apparatus 11 may be configured to perform processing of right shifting mvdAbsVal (basic vector) indicating an absolute value of a motion vector difference by using motion vector scale shiftS (mvdAbsVal=mvdAbsVal>>shiftS). shiftS is also referred to as a shift amount.

Note that the motion vector is constituted by a horizontal component and a vertical component. Therefore, in the actual processing, quantization according to the following formula is performed on a horizontal component mvdAbsVal[0] and a vertical component mvdAbsVal[1].

MvdAbsVal[0]=mvdAbsVal[0]>>shiftS

MvdAbsVal[1]=mvdAbsVal[1]>>shiftS

Then, the image coding apparatus 11 transmits the tow accuracy motion vector to the image decoding apparatus 31.

The image decoding apparatus 31 converts (dequantizes) the accuracy of the motion vector received from the image coding apparatus 11 to the accuracy before it was reduced by the image coding apparatus 11. Specifically, the image decoding apparatus 31 performs processing of left shifting mvdAbsVal (signaling accuracy) indicating the absolute value of the motion vector difference by using shiftS (mvdAbsVal=mvdAbsVal<<shiftS).

Note that the motion vector is constituted by a horizontal component and a vertical component. Therefore, in the actual processing, dequantization according to the following formula is performed on a horizontal component mvdAbsVal[0] and a vertical component mvdAbsVal[1].

MvdAbsVal[0]=mvdAbsVal[0]<<shiftS

MvdAbsVal[1]=mvdAbsVal[1]<<shiftS

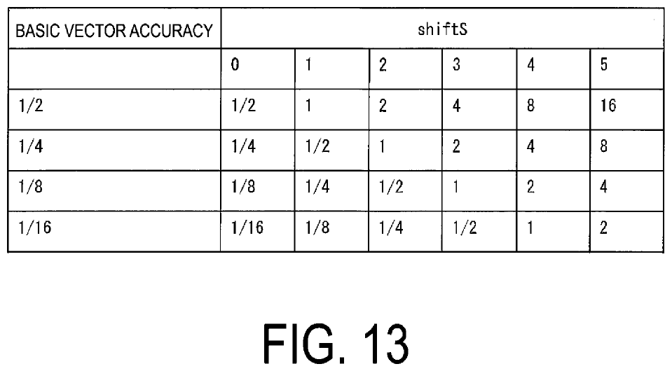

The image coding apparatus 11 may be configured to code a motion vector accuracy flag (mvd_dequant_flag) indicating that the accuracy of the motion vector has been switched, and perform switching from the signaling accuracy of the motion vector. The image coding apparatus 11 may code mvd_dequant_flag and switch accuracy for each difference vector (mvdAbsVal[0], mvdAbsVal[1]). The mvd_dequant_flag may be coded and the accuracy may be switched for each prediction block. For example, the image coding apparatus 11 sets shiftS=0 in a case that mvd_dequant_flag==0 holds true and sets shiftS=2 in a case where mvd_dequant_flag==1 holds true. In a case that the basic vector accuracy is ¼ pixel accuracy, the signaling accuracy of the motion vector in the case where mvd_dequant_flag==0 (shiftS=0) holds true is ¼ pixel accuracy. The signaling accuracy of the motion vector in the case where mvd_dequant_flag==1 (shiftS=2) holds true is 1 pixel accuracy (full PEL). FIG. 13 is a diagram illustrating an example of the relationship among the values of the basic vector accuracy, shiftS, and the signaling accuracy.

Note that the image coding apparatus 11 may be configured to code mvd_dequant_flag only in a case that the difference vector is not the zero vector

### Differential Vector Decoding Process

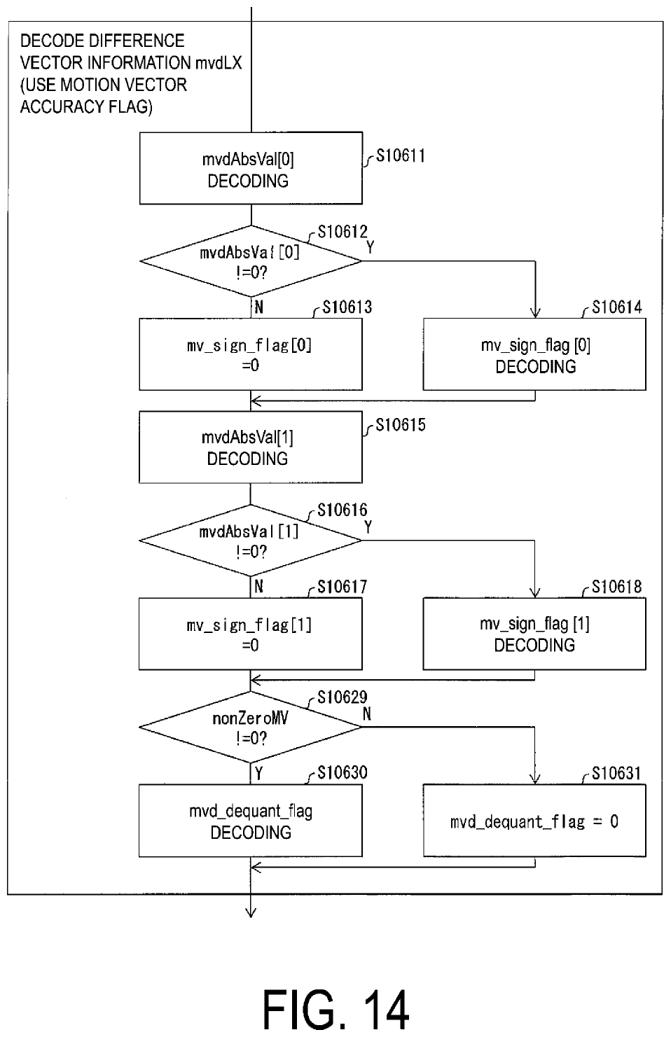

Next, an example in which the inter prediction parameter decoding control unit 3031 performs decoding processing on a difference vector using mvd_dequant_flag will be described with reference to FIG. 14.

FIG. 14 is a flowchart illustrating the difference vector decoding processing in steps S106 and S109 described above more in detail. In the description above, the motion vector and the horizontal and vertical components of the difference vector mvdLX are denoted by mvLX, mvdLX, mvdAbsVal, with no distinction between the horizontal component and the vertical component. However, in order to clarify that the syntax of the horizontal component and the vertical component is required and that processing of the horizontal component and the vertical component is required, the components will be denoted by [0] and [1].

As illustrated in FIG. 14, first, in step S10611, the inter prediction parameter decoding control unit 3031 decodes the syntax mvdAbsVal[0] indicating an absolute value of a horizontal motion vector difference from the coded data, and in step S10612 whether the absolute value of the (horizontal) motion vector difference is 0 (mvdAbsVal[0]!=0) is determined.

In a case that an absolute value of a horizontal motion vector difference mvdAbsVal[0]!=0 holds true (Y in S10612), the inter prediction parameter decoding control unit 3031 decodes a syntax mv_sign_flag[0], which indicates the sign (positive/negative) of the horizontal motion vector difference, from the coded data, and then the processing proceeds to S10615. On the other hand, in a case that mvdAbsVal[0]!=0 does not hold true (N in S10612), in S10613, the inter prediction parameter decoding control unit 3031 sets (infers) mv sign flag[0] to 0 and the processing proceeds to S10615.

Next, in step S10615, the inter prediction parameter decoding control unit 3031 decodes a syntax mvdAbsVal[1] indicating an absolute value of a vertical motion vector difference, and in step S10612 whether the absolute value of the (vertical) motion vector difference is 0 (mvdAbsVal[1]!=0) is determined.

In a case that MvdAbsVal[1]!=0 holds true (Y in S10616), in S10618, the inter prediction parameter decoding control unit 3031 decodes a syntax mv_sign_flag[1], which indicates the sign (positive/negative) of the vertical motion vector difference, from the coded data. On the other hand, in a case that mvdAbsVal[1]!=0 does not hold true (N in S10616), in S10617, the inter prediction parameter decoding control unit 3031 sets a syntax mv_sign_flag[1], which indicates the sign (positive/negative) of the vertical motion vector difference, to 0. After S10617 and S10618, in S10629, the inter prediction parameter decoding control unit 3031 derives a variable nonZeroMV indicating whether the difference vector is 0, and determines whether or not the difference vector is zero (nonZeroMV!=0).

Here, the variable nonZeroMV can be derived from:

nonZeroMV=mvdAbsVal[0]+mvdAbsVal[1]

In a case that nonZeroMV!=0 holds true (Y in S10629), that is, in a case that the difference vector is not 0, in S10630 the inter prediction parameter decoding control unit 3031 decodes the motion vector accuracy flag mvd_dequant_flag from the coded data. In a case that nonZeroMV!=0 does not hold true (N in S10629), the inter prediction parameter decoding control unit 3031 does not decode mvd_dequant_flag from the coded data and sets mvd_dequant_flag to be 0 in S10631. Thus, only in the case where the difference vector is not 0, that is, only in the case where nonZeroMV!=0, the inter prediction parameter decoding control unit 3031 decodes mvd_dequant_flag.

In the above description, each of the absolute value of the motion vector difference mvdAbsVal and the motion vector difference sign mvd_sign_flag is expressed by a vector consisting of {horizontal component and vertical component}, and the horizontal component is accessed with [0] and the vertical component is accessed by [1]. However, the access can be made in other ways such as [0] for vertical components and [1] for horizontal components. The vertical component is processed after the horizontal component. However, the order of the processing is not limited to this. For example, the vertical component may be processed before the horizontal component (the same applies to the following description).

In addition, the inter prediction parameter decoding control unit 3031 may decode mvd_dequant_flag in units of prediction blocks instead of decoding mvd_dequant_flag in the units of difference vectors. Generally, the prediction block includes one or more difference vectors. The inter prediction parameter decoding control unit 3031 may decode mvd_dequant_flag in a case that nonZeroMV of one or more difference vectors included in the prediction block is not 0. In a case that nonZeroMV of all difference vectors included in the prediction block is 0, 0 is derived as mvd_dequant_flag without decoding.

Hereinafter, the difference vector unit or the prediction block unit is also described as a difference vector unit and the like.

### Motion Vector Deriving Processing

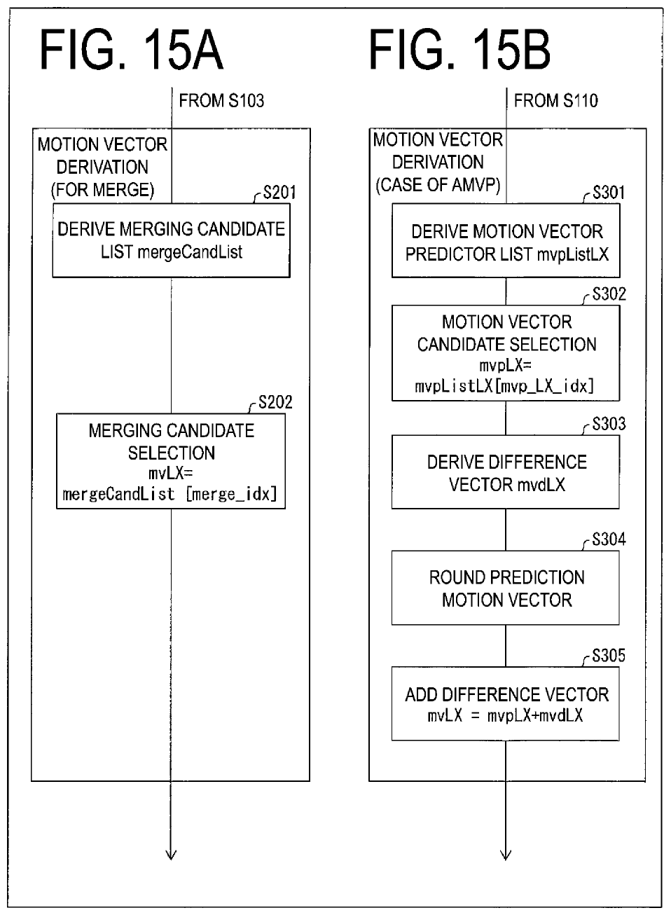

Next, an example of motion vector deriving processing will be described with reference to FIGS. 15A and 15B.

FIG. 15 is a flowchart illustrating a flow of motion vector deriving processing performed by the inter prediction parameter decoding unit 303 according to the present embodiment.

### Motion Vector Deriving Processing in Merging Prediction Mode

FIG. 15A is a flowchart illustrating a flow of motion vector deriving processing in the merging prediction mode. As illustrated in FIG. 15A, in S201, the merging candidate deriving unit 30361 derives a merging candidate list mergeCandList, and in S202, the merging candidate selection unit 30362 selects a merging candidate mvLX indicated by the merging index merge_id based on mergeCandList [merge_idx]. For example, the deriving is performed with mvLX=mergeCandList [merge_idx].

### Motion Vector Deriving Processing in AMVP Mode

In the AMVP mode, a difference vector mvdLX is derived from the decoded syntax mvdAbsVal, mv_sign_flag, and the motion vector mvLX is derived by adding the difference vector mvdLX to the prediction vector mvpLX. In the description for syntax, [0] and [1] are used distinguish between the horizontal component and the vertical component (such as mvdAbsVal[0] and mvdAbsVal[1]. However, in the following description, for the sake of simplicity, simple descriptions such as mvdAbsVal with no distinction between the components is used. Since a motion vector actually includes a horizontal component and a vertical component, the processing described without distinguishing the components may be performed in order for each component.

FIG. 15B is a flowchart illustrating a flow of the motion vector deriving processing in AMVP mode. As illustrated in FIG. 15B, in S301, the vector candidate deriving unit 3033 derives a motion vector predictor list mvpListLX, and in S302, the vector candidate selection unit 3034 selects a motion vector candidate (prediction vector, prediction motion vector) mvpLX=mvpListLX [mvp_LX_idx], which is indicated by the prediction vector index mvp_LX_idx.

Next, in S303, the inter prediction parameter decoding control unit 3031 derives the difference vector mvdLX. As illustrated in S304 in FIG. 15B, the vector candidate selection unit 3034 may perform round processing on the selected prediction vector, Next, in S305, the prediction vector mvpLX and the difference vector mvdLX are added in the addition unit 3035, whereby the motion vector invLX is calculated. That is, mvLX is calculated by mvLX=mvpLX+mvdtX. This calculation is expressed for each component as follows:

mvLX 0=mvpLX [0]+mvdLX [0],

mvLX [1]=mvpLX [1]+mvdLX [1].

### Differential Vector Deriving Processing

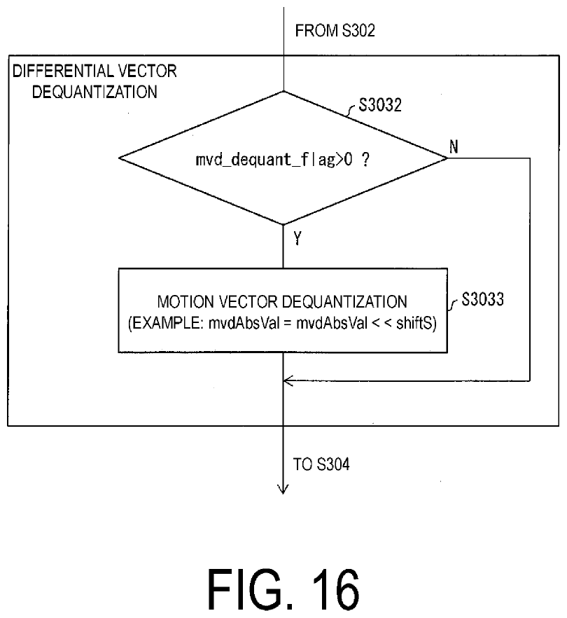

Next, a difference vector deriving processing will be described with reference to FIG. 16. FIG, 16 is a flowchart illustrating the difference vector deriving processing in step S303 described above, more in detail.

The difference vector deriving processing includes dequantization processing (PS_DQMV), that is, processing that dequantizes an absolute value of motion vector difference mvdAbsVal (quantized value), which is a quantized value, to derive the resultant value as an absolute value of a motion vector difference mvdAbsVal of specific accuracy (e.g., a basic vector accuracy described below).

In the following description with reference to FIG. 16, each processing is performed by the inter prediction parameter decoding control unit 3031 unless clearly stated otherwise.

As illustrated in FIG. 16, in S3032, whether flag (mvd_dequant_flag) indicating a switching of motion vector accuracy is larger than 0 is determined. In a case that mvd_dequant_flag>0 holds true (Y in S3032), the difference vector is dequantized by bit shift processing using shiftS, for example, in S3033. More specifically, the bit shift processing is implemented, for example, as processing of left shifting the absolute value of the motion vector difference mvdAbsVal, which is quantized, by shiftS (based on the formula: mvdAbsVal=mvdAbsVal<<shiftS) (processing PS_DQMV0). The processing then proceeds to S304.

In a case that mvd_dequant_flag>0 does not hold true (N in S3032), the processing proceeds to S304 with S3033 skipped. Note that the dequantization of the difference vector to which a shift with a value of 0 (shiftS=0) has been applied does not affect the value of the difference vector. Thus, S3032 may be omitted, and processing in S3033 can be performed instead of being skipped, with shiftS set to 0.

Note that, the determination in S3032 may be implemented based on the determination by the flag (mvd_dequant_flag) indicating the switching of the motion vector accuracy, as well as a determination based on the motion vector scale shiftS.

In this case, in a case that shiftS>0 holds true (Y in S3032), the difference vector is dequantized in S3033, for example, by a bit shift process using shiftS. In a case that shiftS>0 does not hold true, (N in S3032), the processing proceeds to S304 with S3033 skipped.

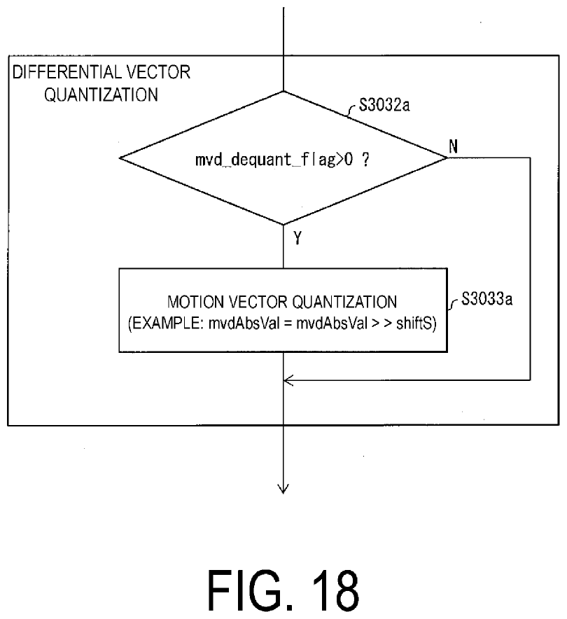

Now, the difference vector quantization processing in the inter prediction parameter coding unit 112 of the image coding apparatus 11 will be described with reference to FIG. 18. FIG. 18 is a flowchart illustrating the difference vector quantization processing by the image coding apparatus 11 more in detail. As illustrated in FIG. 18, in S3032a, whether flag (mvd_dequant_flag) indicating the switching of motion vector accuracy is larger than 0 is determined. In a case that mvd_dequant_flag>0 holds true (Y in S3032a), the difference vector is quantized in S3033a, for example by bit shift processing using shiftS. More specifically, the bit shift processing may be implemented, for example, as processing of right shifting the absolute value of the motion vector difference mvdAbsVal by shiftS (quantization) (as in the formula: mvdAbsVal=mvdAbsVal>>shiftS) (processing PS_QMV0).

Note that in a case that mvd_dequant_flag>0 does not hold true (N in S3032), S3033a is skipped. Note that shifting application at a value of 0 (shiftS=0) (difference vector quantization) does not affect the value of the difference vector. Thus, the processing in S3033a may not be skipped and may be performed with shiftS set to 0.

Note that, the determination in S3032a can be implemented with the determination based on the flag (mvd_dequant_flag) indicating the switching of the motion vector accuracy, as well as the determination based on the motion vector scale shiftS.

In a case that shiftS>0 holds true in this state (Y in S3032a), the difference vector is quantized in S3033a, for example, by the bit shift processing using shiftS. In a case that shiftS>0 does not hold true (N in S3032), S3033a is skipped.

### Prediction Vector Round Processing

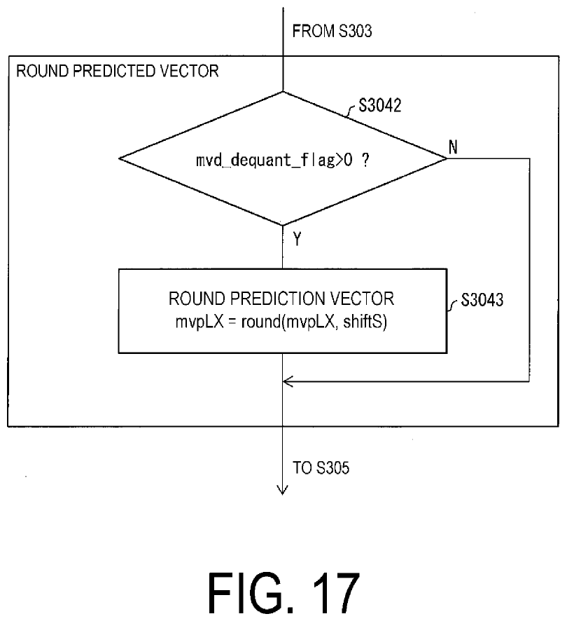

Next, prediction vector round processing (prediction motion vector round processing) will be described with reference to FIG. 17. FIG. 17 is a flowchart illustrating the prediction vector round processing in step S304 described above, more in detail. In the following description with reference to FIG. 17, each processing is performed by a vector candidate selection unit 3034 unless clearly stated otherwise. As illustrated in FIG. 17, in S3042, whether mvd_dequant_flag>0 holds true is determined. In a case that mvd_dequant_flag>0 holds true (Y in S3042), that is, in a case that the dequantization of the difference vector is performed, in S3043, round processing may be performed on the prediction motion vector mvpLX with a round based on a motion vector scale (mvpLX=round (mvpLX, shiftS) (processing PS_PMVROUND), Here, the round (mvpLX, shiftS) represents a function for performing round processing using shiftS, on the prediction motion vector mvpLX. For example, the rounding processing with equations (SHIFT-1) to (SHIFT-4) described below and the like may result in the prediction motion vector mvpLX of a value in units of 1<<shiftS units (values at an interval).

After S304, the processing proceeds to S305. In S305, the motion vector mvLX is derived from the prediction vector mvpLX and the difference vector mvdLX. In a case that mvd_dequant_flag>0 does not hold true (N in S3042), the prediction motion vector mvpLX is not rounded and the processing proceeds to S305 where the motion vector mvLX is derived.

Note that, the determination in S3042 can be implemented with the determination based on the flag (mvd_dequant_flag) indicating the switching of the motion vector accuracy, as well as the determination based on the motion vector scale shiftS.

In this case, in a case that the shiftS>0 holds true (Y in S3042), that is, in a case that the dequantization is performed on the difference vector, in S3043, the round processing may be performed on the prediction motion vector mvpLX with a round based on the motion vector scale shiftS. In a case that shiftS>0 does not hold true (N in S3042 N), the processing proceeds to S305, in which the motion vector mvLX is derived, without rounding the prediction motion vector mvpLX.

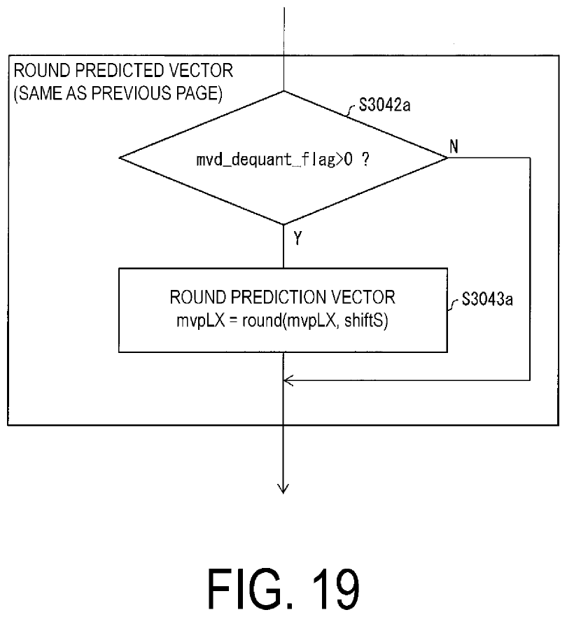

FIG. 19 illustrates an example of a flow of the prediction vector round processing in the inter prediction parameter coding unit 112 of the image coding apparatus 11. As illustrated in FIG. 19, the prediction vector round processing in the image coding apparatus 11 includes steps S3042a and S3043a. The S3042a is the same process as the S3042 described above, and S3043a is the same process as the S3043 described above, and thus detailed description thereof will be omitted.

### Switching of Movement Vector Signaling Accuracy in Picture Unit or Slice Unit

The signaling accuracy of a suitable motion vector varies depending on the performance of the image coding apparatus, the resolution of a picture, and the like. Accordingly, the inter prediction parameter decoding control unit 3031 may switch the accuracy of the motion vector in accordance with the picture or slice of interest.

For example, the inter prediction parameter decoding control unit 3031 may be configured to select the accuracy of the motion vector for each slice header and picture parameter set (PPS).

According to the above-described configuration, the inter prediction parameter decoding control unit 3031 can switch suitable motion vector accuracy for each picture or slice. As a result, the coding efficiency of the image coding apparatus 11 is improved. The inter-prediction parameter decoding control unit 3031 can switch the accuracy of the motion vector using a plurality of stages in accordance with the performance of the image coding apparatus 11 (e.g. in a case that the performance of the image coding apparatus is low, the number of switching stages is one (no switching), and in a case that the performance of the image coding apparatus is medium, the number of switching stages is two, and in a case that the performance of the image coding apparatus is high, the number of switching stages is three, and so on). Details of processing for switching the accuracy of the motion vector in picture units or slice units are as follows. Note that in the examples below, processing for switching the accuracy of the motion vector in slice units will be described as an example, but the accuracy of the motion vector may be switched in the picture units.

### Differential Vector Deriving Processing: Switching Accuracy of Motion Vector in Slice Units

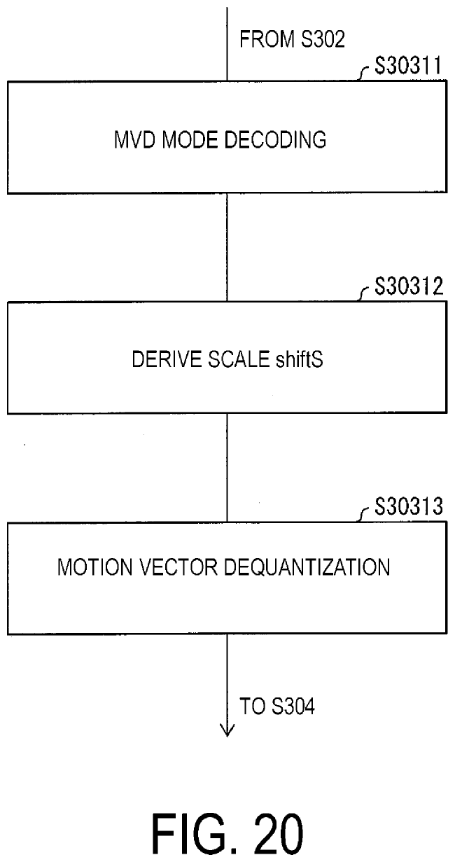

Next, difference vector deriving processing for switching motion vector accuracy in slice units by the inter prediction parameter decoding control unit 3031 will be described with reference to FIG. 20. FIG. 20 is a flowchart illustrating an example of the difference vector deriving processing in step S303 described above.

As illustrated in FIG. 20, the inter prediction parameter decoding control unit 3031 decodes an MVD mode (MVD signaling mode) mvd_dequant_mode from coded data coded in a sequence unit (a sequence parameter set, for example), a picture unit (picture parameter set), and a unit of a specific region or a set of blocks (slice header for example) in a picture (S30311). Furthermore, the inter prediction parameter decoding control unit 3031 decodes the difference vector mvdAbsVal.

Here, the MV signaling mode mvd_dequant_mode is a flag for switching the difference vector accuracy used for signaling in a group of pictures, a picture, a specific region in a picture, and a group of blocks. For example, in a picture, a motion vector may be coded in units of ¼ pixels and a motion vector in another picture may be coded in units of one pixel.

Furthermore, the motion vector accuracy flag mvd_dequant_flag for switching the difference vector accuracy used for the signaling in block units may be used in tandem. For example, depending on the MV signaling mode mvd_dequant_mode, in addition to possible difference vector accuracy in block units, the number of accuracies (value range of mvd_dequant_flag=range of possible values) may be switched. For example, the inter prediction parameter decoding control unit 3031 sets the value of mvd_dequant_flag to 0 in a case that the value of mvd_dequant_mode is 0, and sets the value of mvd_dequant_flag to 0 in a case that the value of mvd_dequant_mode is 1. In addition, in a case that the value of mvd_dequant_mode is 2, the inter prediction parameter decoding control unit 3031 may set the value of mvd_dequant_flag to 0, 1, or 2.

Specifically, in a case that the value of mvd_dequant_mode is not 0, the inter prediction parameter decoding control unit 3031 decodes the motion vector accuracy flag mvd_dequant_flag in a difference vector unit or the like. In a case that the value of mvd_dequant_mode is 1, the inter prediction parameter decoding control unit 3031 decodes mvd_dequant_flag of a value of 0 or 1 in the difference vector units from the coded data. Furthermore, in a case that the value of mvd_dequant_mode is 2, the inter prediction parameter decoding control unit 3031 decodes mvd_dequant_flag of a value 0, 1, or 2 in the difference vector unit from the coded data. Additionally, in a case that mvd_dequant_flag does not exist in the bit stream (do not exist), the inter prediction parameter decoding control unit 3031 sets mvd_dequant_flag to 0. Note that, in a case that the value of mvd_dequant_mode is 0, shiftS is only 0, so the value of mvd_dequant_flag corresponding is identified as a single value of 0. Therefore, the inter prediction parameter decoding control unit 3031 does not decode mvd_dequant_flag.

Next, the inter prediction parameter decoding control unit 3031 dequantizes the difference vector mvdAbsVal (and may further round the prediction vector) based on the MV signaling mode mvd_dequant_mode and the motion vector accuracy flag mvd_dequant_flag. Specifically, the inter prediction parameter decoding control unit 3031 derives the shift amount shiftS used for dequantization of the difference vector mvdAbsVal based on mvd_dequant_mode and mvd_dequant_flag (S30312).

For example, the inter prediction parameter decoding control unit 3031 may derive shiftS in branch processing in accordance with a value of mvd_dequant_flag as follows.

shiftS=(mvd_dequant_flag==0)?0: (mvd_dequant_flag==1)?1:2

The inter-prediction parameter decoding control unit 3031 uses shiftSTb1, which is a table from which shiftS is derived to, derive shiftS by shiftS=shiftSTb1 [mvd_dequant_flag]. For example, the inter prediction parameter decoding control unit 3031 sets shiftS to 0, 2, and 4 respectively in cases Where the value of mvd_dequant_flag is 0, the value of mvd_dequant_flag is 1, and mvd_dequant_flag is 2 with shiftSTb1 configured to be shiftSTb1 [ ]={0, 2, 4}.

Next, the inter prediction parameter decoding control unit 3031 performs processing invdAbsVal=mvdAbsVal<<shiftS for left shifting the difference vector mvdAbsVal using the derived shiftS, to dequantize the difference vector mvdAbsVal (and may further round the prediction vector) (S30313). For example, in a case that the basic vector accuracy is ¼ pixel accuracy, the accuracy of the dequantized difference vector mvdAbsVal will be as follows.

In a case that shiftS is 0, the accuracy is ¼ pixel accuracy that is the same as the base vector accuracy. In a case that shiftS is 2 or 4, the accuracy (signaling accuracy) of the dequantized difference vector mvdAbsVal is 1 pixel accuracy or 4 pixel accuracy, respectively.

According to the above-described configuration, in a case that mvd_dequant_mode is 0, the accuracy of the difference vector mvdAbsVal in the coded/decoded region is ¼ pixel accuracy (shiftS=0). In a case that mvd_dequant_mode is 1, the accuracy of the difference vector mvdAbsVal in the coded/decoded region is 1 or ¼ pixel accuracy (shiftS=0 or 2). In a case that mvd_dequant_mode is 2, the accuracy of the difference vector mvdAbsVal is set to 4 pixel accuracy, 1 pixel accuracy, or ¼ pixel accuracy (shiftS=0 or 2 or 4). Accordingly, the inter prediction parameter decoding control unit 3031 switches the signaling accuracy of the motion vector in accordance with a mode (mvd_dequant_mode) configured in a predetermined region (slice or picture) including a plurality of blocks.

Furthermore, as described above, the inter prediction parameter decoding control unit 3031 may switch the accuracy of the difference vector using a number of stages (accuracy) corresponding to the value of mvd_dequant_mode.

The inter prediction parameter decoding control unit 3031 may shift a difference vector based on a shift amount configure for each difference vector based on the MV signaling mode decoded from coded data in a predetermined region including a plurality of prediction blocks in the reference image and the motion vector accuracy flag decoded from coded data for each prediction block or difference vector, and may derive the motion vector of the prediction block based on a sum of the shifted difference vector and the prediction vector.

The inter-prediction parameter decoding control unit 3031 derives a shift amount (shiftS) configured for each of the prediction blocks or difference vectors identified by the MV signaling flag (mvd_dequant_flag) the value range of which is configured based on the MVsignaling mode (mvd_dequant_mode) configured for a predetermined region (slice or picture) including a plurality of prediction blocks in the reference image. Then, the inter prediction parameter decoding control unit 3031 may shift the difference vector using the derived shift amount, and derive a motion vector of the prediction block based on a sum of the shifted difference vector and the prediction vector.

In addition, the inter prediction parameter decoding control unit 3031 identifies the shift amount from one shift amount, two different shift amounts, or three different shift amounts, depending on the value range corresponding to mvd_dequant_mode.

Another example of relationship between the value of mvd_dequant_mode and the accuracy of the difference vector will be described below. For example, in a case that mvd_dequant_mode is 0, the inter prediction parameter decoding control unit 3031 derives mvd_dequant_flag=0, and sets the accuracy of the difference vector mvdAbsVal to ¼ pixel accuracy. In a case that mvd_dequant_mode is 1, the inter prediction parameter decoding control unit 3031 decodes 0 or 1 mvd_dequant_flag, and configures the accuracy of the difference vector mvdAbsVal to be ¼ pixel accuracy or 1 pixel accuracy (two stages). In a case that mvd_dequant_mode is 2, the inter prediction parameter decoding control unit 3031 decodes 0 or 1 mvd_dequant_flag, and configures the accuracy of the difference vector mvdAbsVal to be ½ pixel accuracy or 2 pixel accuracy (two stages). In a case that mvd_dequant_mode is 3, the inter prediction parameter decoding control unit 3031 decodes 0 or 1 mvd_dequant_flag, and configures the accuracy of the difference vector mvdAbsVal to be 1 pixel accuracy or 4 pixel accuracy (two stages).

In the above-described processing, the inter prediction parameter decoding control unit 3031 derives shiftS based on mvd_dequant_mode and mvd_dequant_flag as follows, and performs dequantization of the difference vector.

In a case that mvd_dequant_mode==0
shifts=0

In a case that mvd_dequant_mode==1
shiftS==0 (mvd_dequant_flag=0), 2 (mvd_dequant_flag=1)

In a case that mvd_dequant_mode==2
shiftS=1 (mvd_dequant_flag==0), 3 (mvd_dequant_flag=1)

In a case that mvd_dequant_mode=3
shiftS=2 (mvd_dequant_flag==0), 3 (mvd_dequant_flag==1)

According to the above-described configuration, by configuring mvd_dequant_mode in accordance with the resolution and the characteristics of the sequence, it is possible to signal the motion vector with appropriate accuracy and achieve high coding efficiency. For example, the switching in a case that mvd_dequant_mode is 0 may be applied, for example, to a case that the amount of calculation available in images of normal resolution HD) is relatively small. In addition, the switching in the case where mvd_dequant_mode is 1 may be applied, for example, to a case that the amount of calculation available at normal resolution (e.g., resolution of HD) is relatively large. Alternatively, the switching in the case where mvd_dequant_mode is 2 may be applied to an image with high resolution (e.g., resolution of 4 K), for example. Alternatively, the switching in the case where mvd_dequant_mode is 3 may be applied to an image with an ultra-high resolution (e.g., resolution of 16 k), for example.

In other words, mvd_dequant_flag identifies the shift amount from one shift amount or two different shift amounts depending on the value range corresponding to mvd_dequant_mode.

### Differential Vector Deriving Processing: Accuracy of Motion Vector Switched in Both Picture/Slice Units and Block Units

Next, an example of difference vector derivation with motion vector accuracy switched with both picture/slice units and block units will be described.

In the present example, the inter prediction parameter decoding control unit 3031 derives the shift amount shiftS used for the dequantization of the difference vector mvdAbsVal from two elements. Specifically, the inter prediction parameter decoding control unit 3031 derives the shift amount shiftS by performing processing of calculating a sum of the block scale blockS, which is a component that changes the shift amount shiftS in the difference vector unit (or the prediction block unit) and an upper scale addS, which is a component that changes in picture units or slice units.

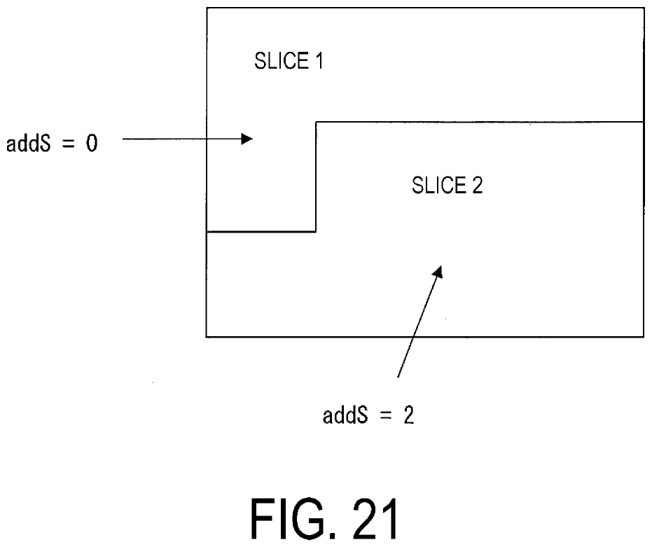

FIG. 21 is a diagram illustrating an example of deriving the higher scale addS configured for each slice. As illustrated in FIG. 21, in the picture composed of slice 1 and slice 2, addS=0 is configured for slice 1. Meanwhile, addS=2 is configured for slice 2. Accordingly, the inter prediction parameter decoding control unit 3031 can switch the accuracy of the motion vector for each slice. Note that a case where addS of a certain value is configured means that mvd_dequant_mode is decoded on a slice unit (or picture unit), and addS of the above-described configuration is derived. For example, mvd_dequant_mode may be coded by slice header, SPS, PPS, and the like.

Additionally, the addS may be derived in a picture unit. An example of the motion vector signaling accuracy in a case that addS=0 is configured for a low-resolution picture and addS=1 is configured for a high-resolution picture will be described. In a case that the signaling accuracy of the motion vector in the low-resolution picture is ¼ pixel accuracy or 1 pixel accuracy, the signaling accuracy of the motion vector in the high resolution picture has a value of addS that is ½ pixel accuracy or 2 pixel accuracy.

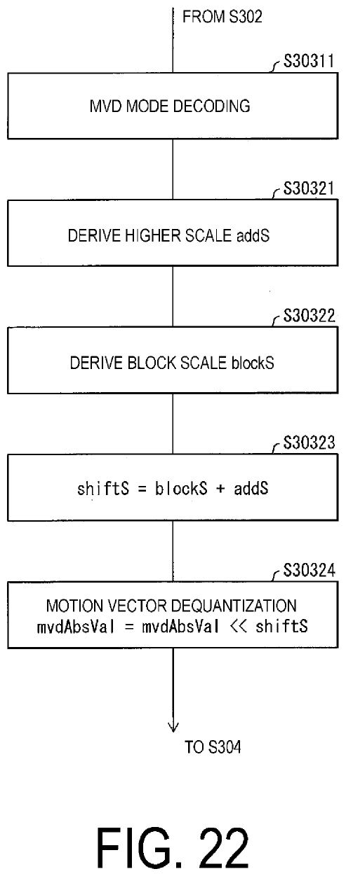

Next, difference vector deriving processing for switching motion vector accuracy for switching the motion vector accuracy in both the picture/slice unit and the block unit will be described with reference FIG. 22. FIG. 22 is a flowchart illustrating an example of the difference vector deriving processing in step S303 described above.

As illustrated in FIG. 22, the inter prediction parameter decoding control unit 3031 decodes an MVD mode (MV signaling mode) mvd_dequant_mode from coded data coded in a sequence unit (e.g., sequence parameter set SPS), a picture unit (e.g., picture parameter set PPS), and a particular region a group of blocks of the picture (e.g., slice header, tile header/tile information) (S30311). Furthermore, the inter prediction parameter decoding control unit 3031 decodes the difference vector mvdAbsVal. Next, the inter prediction parameter decoding control unit 3031 derives the higher scale addS based on mvd_dequant_mode (S30321) example, addS=0, 0, 1, and 2 is derived, respectively, in cases where mvd_dequant_mode==0, 1, 2, and 3. The inter prediction parameter decoding control unit 3031 may derive addS by conditional branch as described below.

addS=mvd_dequant_mode==0?0:mvd_dequant_mode 1?0: mvd_dequant_mode==2?1:2

The inter prediction parameter decoding control unit 3031 may derive addS from table reference as described below.

addS=addSTb1 [mvd_dequant_mode],
where STb1 []=(0, 0, 1, 2).

Of course, the relationship between mvd_dequant_mode and addS is not limited to the above relationship. For example, addS=0 and 1 may be derived for mvd_dequant_mode==0 and 1, respectively, or addS=0, 1, and 2 may be derived in mvd_dequant_mode==0, 1, and 2, respectively.

According to the above-described configuration, by configuring mvd_dequant_mode in accordance with the resolution and the characteristics of the sequence, it is possible to signal the motion vector with appropriate accuracy and achieve high coding efficiency. For example, the switching in a case that mvd_dequant_mode is 0 may be applied, for example, to a case that the amount of calculation available in images of normal resolution (e.g., HD) is relatively small. In addition, the switching in the case where mvd_dequant_mode is 1 may be applied, for example, to a case that the amount of calculation available at normal resolution (e.g., resolution of HD) is relatively large. Alternatively, the switching in the case where mvd_dequant_mode is 2 may he applied to an image with high resolution (e.g., resolution of 4 K), for example. Alternatively, the switching in the case where mvd_dequant_mode is 3 may be applied to an image with an ultra-high resolution (e.g., resolution of 16 K), for example.

Next, the inter prediction parameter decoding control unit 3031 decodes or derives mvd_dequant_flag and derives a block scale blockS based on mvd_dequant_flag (S30322). Note that in a case that the value of mvd_dequant_mode is 0, 0 is derived as shiftS, that is, 0 is derived as blockS. Specifically, since the value of mvd_dequant_flag is identified as a single value which is 0, the inter prediction parameter decoding control unit 3031 does not decode the flag mvd_dequant_flag from the coded data in the difference vector unit or the like. In a case that the value of mvd_dequant_mode is other than 0, the inter prediction parameter decoding control unit 3031 decodes the motion vector accuracy flag mvd_dequant_flag in the difference vector unit or the like. In a case that mvd_dequant_mode is 1, the inter prediction parameter decoding control unit 3031 decodes mvd_dequant_flag that is 0 or 1 and configures the accuracy of the difference vector mvdAbsVal to ¼ pixel accuracy or 1 pixel accuracy (two stages). In a case that mvd_dequant_mode is 2, the inter prediction parameter decoding control unit 3031 decodes mvd_dequant_flag that is 0 or 1, and configures the accuracy of the difference vector mvdAbsVal to be ½ pixel accuracy or 2 pixel accuracy (two stages). In a case that mvd_dequant_mode is 3, the inter prediction parameter decoding control unit 3031 decodes mvd_dequant_flag that is 0 or 1, and configures the accuracy of the difference vector mvdAbsVal to be 1 pixel accuracy or 4 pixel accuracy (two stages).

As described above, the inter prediction parameter decoding control unit 3031 may determine the value range of mvd_dequant_flag in accordance with mvd_dequant_mode. The inter prediction parameter decoding control unit 3031 decodes mvd_dequant_flag of a value in the determined range from the coded data. For example, in a case that the value of mvd_dequant_mode is 0, then mvd_dequant_flag is determined to be 0 only. In a case that the value of mvd_dequant_mode is from 1 to 3, the value of mvd_dequant_flag is determined to be 0 or 1. Additionally, in a case that mvd_dequant_flag does not exist in the bit stream (do not exist), the inter prediction parameter decoding control unit 3031 sets mvd_dequant_flag to 0. Next, the inter prediction parameter decoding control unit 3031 uses shiftSTb1 to derive blockS by blockS=shiftSTb1 [mvd_dequant_flag].

For example, blockS is derived as 0 and 2 respectively in cases where the value of mvd_dequant_flag is 0 and 1, with shiftSTb1 configured to be shiftSTb1 [ ]={0, 2}.

Next, the inter prediction parameter decoding control unit 3031 derives shiftS (S30323). Specifically, the inter prediction parameter decoding control unit 3031 derives shiftS by processing of adding addS to blockS (shiftS=blockS+addS).

Next, the inter prediction parameter decoding control unit 3031 dequantizes the difference vector mvdAbsVal (and may further round the prediction vector). Specifically, the inter prediction parameter decoding control unit 3031 dequantizes the difference vector mvdAbsVal by performing processing of left shifting difference vector mvdAbsVal by using the derived shiftS (mvdAbsVal=mvdAbsVal<<shiftS) (S30313).

For example, in a case that the basic vector accuracy is ¼ pixel accuracy, the accuracy of the motion vector is switched as follows: As described above, in a case that mvd_dequant_mode is 0, addS is derived as 0, shiftS is derived as 0. Thus, ¼ pixel accuracy which is the same as the basic vector accuracy is used as the accuracy of the dequantized difference vector mvdAbsVal.

In a case that mvd_dequant_mode is 1, addS is derived as 0, blockS is derived as 0 or 2, and shiftS is derived as 0 or 2. Thus, ¼ pixel accuracy or 1 pixel accuracy is used as the accuracy of the dequantized difference vector mvdAbsVal.

In a case that mvd_dequant_mode is 2, addS is derived as 1, and blockS is derived to 0 or 2, shiftS as 1 or 3. As a result, the accuracy of the dequantized difference vector mvdAbsVal is ½ pixel accuracy or 2 pixel accuracy.

In a case that mvd_dequant_mode is 3, addS is derived as 2, blockS is derived as 0 or 2, and shiftS is derived as 2 or 4. Thus, 1 pixel accuracy or 4 pixel accuracy is used as the accuracy of the dequantized difference vector mvdAbsVal.

In other words, the inter prediction parameter decoding control unit 3031 shifts the difference vector with respect to the prediction block using the shift amount (addS) configured in a predetermined region including a plurality of prediction blocks in the reference image and the shift amount (blockS) configured for each prediction block.

Note that in the example described above, an example is given in which mvd_dequant_mode determines mvd_dequant_flag value range. Still, the configuration provided in the present example may be any configuration in which shiftS is derived from a sum of blockS and addS, and the configuration in which mvd_dequant_mode determines a value range of mvd_dequant_flag is not an essential configuration.

Another example of the relationship between the value of mvd_dequant_mode and the accuracy of the difference vector will be described below. For example, in a case that mvd_dequant_mode is 0, the accuracy of the difference vector mvdAbsVal is ¼ pixel accuracy (one stage), and in a case that mvd_dequant_mode may be 1, the accuracy of the difference vector mvdAbsVal may be 1 pixel accuracy or ¼ pixel accuracy (two stages), and in a case that mvd_dequant_mode is 2, the accuracy of the difference vector mvdAbsVal may be 4 pixel accuracy, 1 pixel accuracy, or ½ pixel accuracy (three stages).

Switching of Movement Vector Signaling Accuracy Based on Picture size of Target Picture

Next, an example of switching the motion vector signaling accuracy in a picture unit different from the one in the above-described example will be described. The inter prediction parameter decoding control unit 3031 according to the present example switches the accuracy of the motion vector in accordance with the picture size of the target picture (resolution of the image).

According to the above-described configuration, even in a case that the image size increases and the motion vector increases, the image coding apparatus 11 can code the motion vector with a relatively small amount of code. As a result, the coding efficiency of the image coding apparatus 11 is improved.

Next, difference vector deriving processing for switching the accuracy of the motion vector based on the picture size of the picture by the inter prediction parameter decoding control unit 3031 will be described with reference to FIGS. 22 to 25. Note that in difference vector deriving processing that switches the accuracy of the motion vector in accordance with the image size of the picture, the inter prediction parameter decoding control unit 3031 does not perform the decoding processing on mvd_dequant_mode, as in S30311 of FIG. 22.

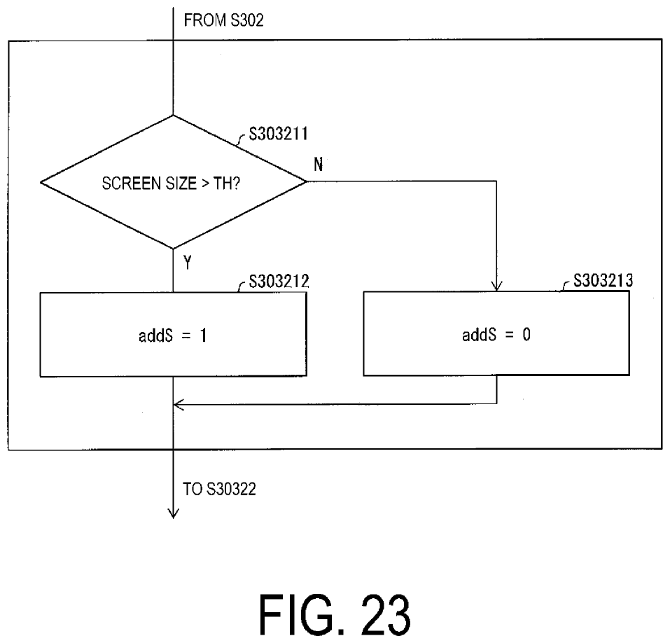

As illustrated in FIG. 22, the inter prediction parameter decoding control unit 3031 derives a higher scale (S30321). Details of the higher scale derivation will be described with reference to FIG. 23. FIG. 23 is a diagram illustrating details of derivation of a higher scale addS. As illustrated in FIG. 23, the inter prediction parameter decoding control unit 3031 determines whether the picture size of the target picture is larger than a threshold value (TH) (S303211). For example, examples of the threshold include picture size 4 k and the like. In a case that the picture size of the target picture is larger than the threshold (Y in S303211), the inter prediction parameter decoding control unit 3031 derives addS=1, and the processing proceeds to S30322. In a case that the picture size of the target picture is less than or equal to the threshold value (N in S303211), the inter prediction parameter decoding control unit 3031 derives addS=0, and the processing proceeds to S30322.

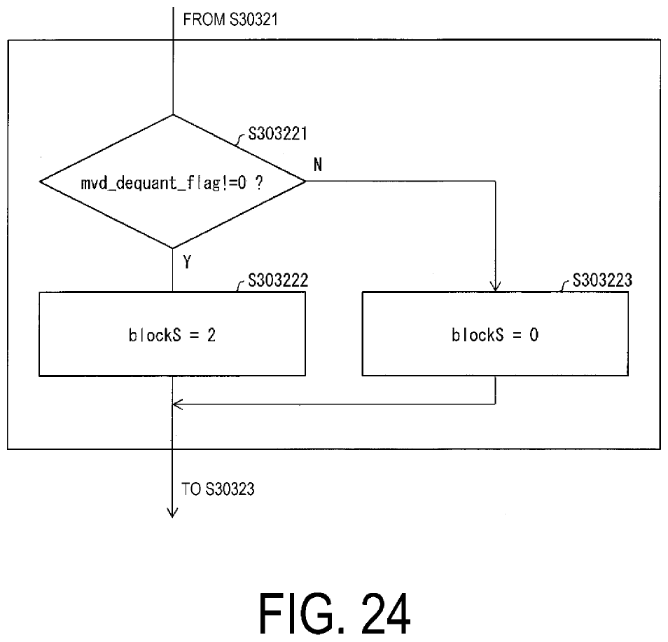

Next, the inter prediction parameter decoding control unit 3031 derives a block scale blockS (S30322). Details of the derivation of the block scale blockS will be described with reference to FIG. 24. FIG. 24 is a diagram illustrating details of the derivation of block scale blockS. As illustrated in FIG. 24, the inter prediction parameter decoding control unit 3031 decodes mvd_dequant_flag from the coded data by a difference vector unit or the like, and derives blockS based on mvd_dequant_flag. The inter prediction parameter decoding control unit 3031 determines whether the value of mvd_dequant_flag is other than 0 (S303221). In a case that mvd_dequant_flag is other than 0 (Y in S303221), the inter prediction parameter decoding control unit 3031 derives blockS=2, and the processing proceeds to S30323. In a case that mvd_dequant_flag is 0 (N in S303221), the inter prediction parameter decoding control unit 3031 derives blockS=1, and the processing proceeds to S30323. Note that the inter prediction parameter decoding control unit 3031 may derive blockS using shiftSTb1, as in “Differential Vector Deriving Processing: Switching Accuracy of the Motion Vector in Both Slice Unit and Block Unit” described above.

The processing in S30323 and S30324 is the same as the process described above, and thus detailed descriptions thereof will be omitted.

In other words, the processing described above may be described as processing in which the inter prediction parameter decoding control unit 3031 shifts the difference vector using the shift amount (addS) based on the size of the resolution of the reference image and the shift amount identified by the flag (mvd_dequant_flag) set for each prediction block.

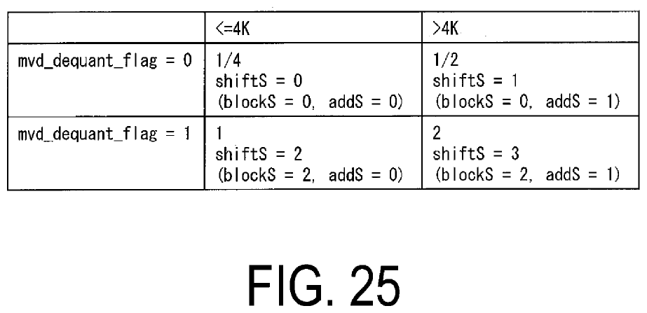

Here, an example of the accuracy of the shift amount shiftS and the motion vector derived from the value indicated by the motion vector accuracy flag mvd_dequant_flag decoded from the coded data by picture size, difference vector units, and the like will be described with reference to FIG. 25. FIG. 25 is a diagram illustrating an example of the accuracy of the shiftS and motion vectors derived from the picture size and the value indicated by the flag. Note that the basic vector accuracy is ¼ pixel accuracy. As illustrated in FIG. 25, in a case that the picture size is equal to or less than 4 k and mvd_dequant_flag is 0, addS is 0, blockS is 0, and shiftS is 0. Thus, the accuracy of the dequantized difference vector mvdAbsVal is ¼ pixel accuracy that is the same as the base vector accuracy.

In a case that the picture size is equal to or less than 4 k and mvd_dequant_flag is 1, addS is derived as 0, blockS is derived as 2, and shiftS is derived as 2. Thus, 1 pixel accuracy is used as the accuracy of the dequantized difference vector mvdAbsVal.

In a case that the picture size is greater than 4 k (e.g., 8 K) and mvd_dequant_flag is 0, addS is derived as 0, and shiftS is derived as 1. As such, ½ pixel accuracy is used as the accuracy of the dequantized difference vector mvdAbsVal.

In a case that the picture size is greater than 4 k (e.g., 8 K) and mvd_dequant_flag is 1, addS is derived as 1, blockS is derived as 2, and shiftS is derived as 3. Thus, 2 pixel accuracy is used as the accuracy of the dequantized difference vector mvdAbsVal.

Example of Switching blockS by Three Stages

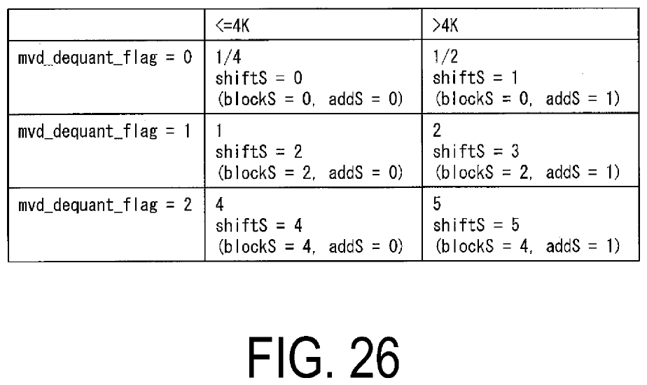

In the example described above, an example of switching the motion vector accuracy by two stages (blockS by two stages) with a difference vector unit or the like (example where mvd_dequant_flag has two values). Now, an example is described in which motion vector accuracy is switched by three stages (an example where blockS is switched by three stages, and the mvd_dequant_flag has three values) will be described with reference to FIGS. 22 and 26.

As illustrated in FIG. 22, the inter prediction parameter decoding control unit 3031 derives a higher scale (S30321). Specifically, the inter prediction parameter decoding control unit 3031 derives addS by addS=picture size >4 K?1:0. In other words, the inter prediction parameter decoding control unit 3031 determines whether the picture size of the target picture is greater than 4 k, and derives the value of addS as 1 or 0 in accordance with the determination result. The determination of the picture size may employ comparing a product of the width and height of the image (width*height), a sum of the width and height (width+height), or the like with a threshold value.

Next, the inter prediction parameter decoding control unit 3031 derives a block scale blockS (S30322). For example, the inter prediction parameter decoding control unit 3031 uses shiftSTb1,which is a table for deriving blockS, and derive shiftS by blockS=shiftSTb1 [mvd_dequant_flag]. For example, use of shiftSTb1 [ ]={0, 2, 4} as the table shiftSTb1 results in shiftS being derived as 0, 2, and 4 respectively in cases that the mvd_dequant_flag value is 0, 1, and 2.

The processing in S30323 and S30324 is the same as the process described above, and thus detailed descriptions thereof will be omitted.

An example of shiftS and the accuracy of the motion vector derived from the picture size and the value indicated by mvd_dequant_flag will be described with reference to FIG. 26. FIG. 26 is a diagram illustrating an example of shiftS and the accuracy of the motion vector derived from the picture size and the value indicated by the flag Note that the basic vector accuracy is ¼ pixel accuracy. As illustrated in FIG. 26, in a case that the picture size is equal to or less than 4 k and mvd_dequant_flag is 0, addS is derived as 0, blockS is derived as 0 and shiftS is derived as 0. Thus, ¼ pixel accuracy which is the same as the basic vector accuracy is used as the accuracy of the dequantized difference vector mvdAbsVal.

In a case that the picture size is equal to 4 k or less than 4 k and mvd_dequant_flag is 1, addS is derived as 2, blockS is derived as 2, and shiftS is derived as 2. Thus, 1 pixel accuracy is used as the accuracy of the dequantized difference vector mvdAbsVal.

In a case that the picture size equal to or less than 4 k and mvd_dequant_flag is 2, addS is derived as 4 and shiftS is derived as 4. Thus, 4 pixel accuracy is used as the accuracy of the dequantized difference vector mvdAbsVal.

In a case that the picture size is greater than 4 k (e.g., 8 K) and mvd_dequant_flag is 0, addS is derived as 0, blockS is derived as 0, and shiftS is derived as 1. As such, ½ pixel accuracy is used as the accuracy of the dequantized difference vector mvdAbsVal.

In a case that the picture size is greater than 4 k (e.g., 8 K) and mvd_dequant_flag is 1, addS is derived as 1, blockS is derived as 2, and shiftS is derived as 3. Thus, 2 pixel accuracy is used as the accuracy of the dequantized difference vector mvdAbsVal.

In a case that the picture size is greater than 4 k (e.g., 8 K) and mvd_dequant_flag is derived as 2, addS is derived as 1, blockS is derived as , and shiftS is derived as 5. Thus, 5 pixel accuracy is used as the accuracy of the dequantized difference vector mvdAbsVal.

As another example of switching blockS by multiple stages (here, three stages), for example, the inter prediction parameter decoding control unit 3031 may determine to divide the picture size of the target picture in three (e.g. 4 k, 8 k, and 16 k), and may derive addS values in accordance with the determination result. In the present configuration, the accuracy of the difference vector mvdAbsVal described below may be added to the accuracy of the dequantized difference vector mvdAbsVal as described in “the example of switching blockS by three stages”. For example, in a case that the picture size of the target picture is 16 k, the accuracy of the dequantized difference vector mvdAbsVal is any one of 8 pixel accuracy, 2 pixel accuracy, and ½ pixel accuracy.

### Switching Motion Vector Signaling Accuracy Based on Horizontal Component and Direction of Vertical Component of Difference Vector

In a motion vector, the horizontal component tends to be large and the vertical component tend to be small. On the other hand, in a case that the signaling accuracy of the motion vector is switched in a uniform manner without taking the direction of each component in to consideration, the vertical accuracy of the motion vector might not be sufficient.

The inter prediction parameter decoding control unit 3031 according to the present example switches the signaling accuracy of the horizontal component and the signaling accuracy of the difference vector based on directions of the horizontal component and the vertical component (horizontal or vertical) of the difference vector. For example, the horizontal component of the difference vector is roughly configured and the vertical component is configured in detail. Thus, the values are configured so that a horizontal scale scaleSHor of the motion vector>a vertical scale scaleSVer of the motion vector holds true.

In other words, the inter prediction parameter decoding control unit 3031 shifts the horizontal component and the vertical component of the difference vector using the shift amount corresponding to each direction.

With the above-described configuration, the inter prediction parameter decoding control unit 3031 can reduce the accuracy of the horizontal component of the motion vector and maintain the accuracy of the vertical component. Therefore, the prediction accuracy of the image decoding apparatus 31 can be improved.

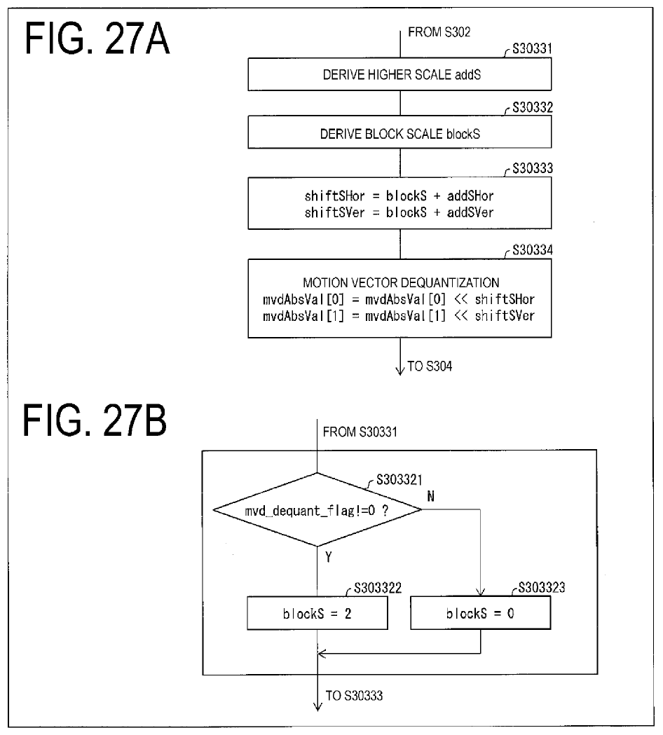

Next, with reference to FIGS. 27A and 27B, FIGS. 28A and 28B, and FIG. 29, a description is given on difference vector deriving processing performed by the inter prediction parameter decoding control unit 3031 for switching the accuracy of the horizontal component and the vertical component of the difference vector based on the directions of the horizontal component and the vertical component direction (horizontal or vertical) of the difference vector. FIG. 27A is a flowchart illustrating the above-described difference vector deriving processing in step S303 according to the present example, more in detail.

As illustrated in FIG. 27A, the inter prediction parameter decoding control unit 3031 derives a higher scale (S30331). Specifically, the inter prediction parameter decoding control unit 3031 derives addSVer, which is addS for the vertical component of the difference vector, as 0. The inter prediction parameter decoding control unit 3031 derives addSHor, which is addS for the horizontal component of the difference vector, as 1. Thus, addSVer and addSHor are configured to be different values.

Next, the inter prediction parameter decoding control unit 3031 derives the block scale blockS (S30332). Specifically, the inter prediction parameter decoding control unit 3031 decodes mvd_dequant_flag from the coded data by a difference vector unit or the like, and derives blockS in accordance with mvd_dequant_flag. Here, blockS may be derived using the table shiftSTb1 (blockS=shiftSTb1 [mvd_dequant_flag]). Note that blockS is common to the horizontal component and the vertical component of the difference vector.

For example, in a case that shiftSTb1 is configured to be shiftSTb1 [ ]=, {0, 2}, blockS would be 0 in a case that the value of mvd_dequant_flag is 0, and would be 2 in a case that the value of mvd_dequant_flag is 1. Another example of derivation of blockS will be described with reference to FIG. 27B. FIG. 27B is a diagram illustrating an example of derivation of the block scale blockS. As illustrated in FIG. 27B, the inter prediction parameter decoding control unit 3031 decodes mvd_dequant_flag from the code data by a difference vector unit or the like, and derives blockS based on mvd_dequant_flag. The inter prediction parameter decoding control unit 3031 determines whether the value of mvd_dequant_flag is other than 0 (S303321). In a case that mvd_dequant_flag is other than 0 (Y in S303321), the inter prediction parameter decoding control unit 3031 derives blockS=2 (S303322) and the processing proceeds S30333. In a case that mvd_dequant_flag is 0 (N in S303321), the inter prediction parameter decoding control unit 3031 derives blockS=0 (S303322) and the processing proceeds S30333.

Next, the inter prediction parameter decoding control unit 3031 derives shiftSHor, which is shiftS for the horizontal component of the difference vector, and shiftSVer, which is shiftS for the vertical component of the difference vector (S30333). Specifically, the inter prediction parameter decoding control unit 3031 adds addSHor or adds Ver to blockS (shiftSHor=blockS+addSHor, shiftSVer=blockS+addSVer) to derive shiftSHor and shiftSVer.

Next, the inter prediction parameter decoding control unit 3031 dequantizes the syntax (vertical component) mvdAbsVal[1], which indicates the syntax (horizontal component) mvdAbsVal [0] indicating the absolute value of the horizontal motion vector difference and the syntax (vertical component) mvdAbsVal [1] indicating the absolute value of the vertical motion vector difference. Specifically, the inter prediction parameter decoding control unit 3031 performs processing of left shifting mvdAbsVal[0] and mvdAbsVal[1] using the derived shiftSHor and shiftSVer (mvdAbsVal[0]=mvdAbsVal[0]<<shiftSHor, mvdAbsVal[1]=mvdAbsVal[1]<<shiftSVer) to dequantize the difference vector mvdAbsVal (and may also round the prediction vector) (S30334).

As a result of the processing described above, the accuracy of the vertical component of the dequantized difference vector may be ½ pixel accuracy or ⅛ pixel accuracy, and the accuracy of the horizontal component of the dequantized. difference vector may be 1 pixel accuracy or ¼ pixel accuracy.

The accuracy of the vertical component of the dequantized difference vector may be 1 pixel accuracy or ¼ pixel accuracy, and the accuracy of the horizontal component of the dequantized difference vector may be 2 pixel accuracy or ½ pixel accuracy.

Other Examples of Difference Vector Deriving Processing for Switching the Signal Accuracy of the Horizontal Component and the Vertical component of the Difference Vector

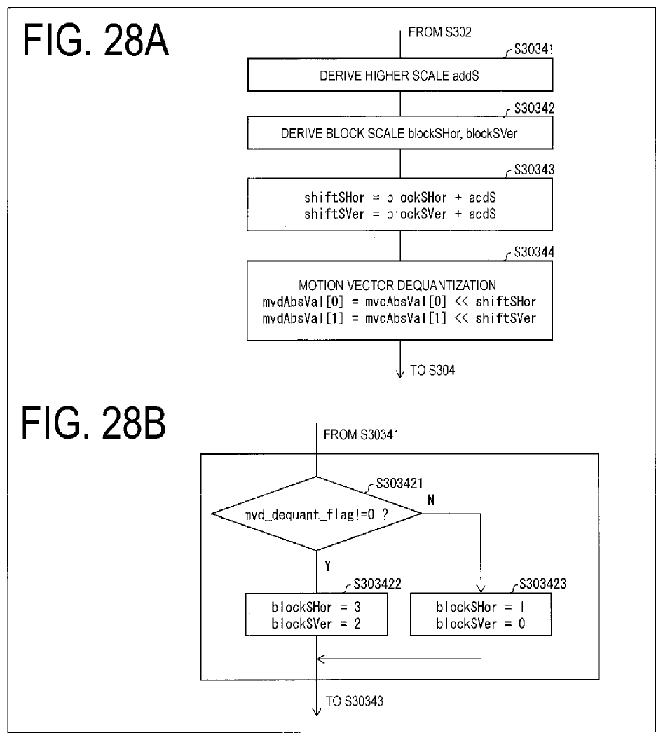

FIG. 28A is a flowchart illustrating another example of the difference vector deriving process in step S303.

As illustrated in FIG. 28A, the inter prediction parameter decoding control unit 3031 derives a higher scale (S30341). Specifically, the inter prediction parameter decoding control unit 3031 derives addS as a common value for the horizontal component and the vertical component of the difference vector. Note that addS may be changed according to mvd_dequant_mode or the picture size of the target picture described in the above example, or may have a fixed value (e.g., addS=0).

Next, the inter prediction parameter decoding control unit 3031 derives blockSVer and blockSHor for the horizontal component and the vertical component of the difference vector as different values (S30342). For example, the inter prediction parameter decoding control unit 3031 uses shiftSTb1Ver and shiftSTb1Hor, which are tables for deriving blockSVer and blockSHor (blockSVer=shiftSTb1Ver [mvd_dequant_flag], blockSHor=shiftSTb1Hor [mvd_dequant_flag]) to derive blockSVer and blockSHor. For example, shiftSTb1Hor may be {1, 3} with shiftSTblVer being {0, 2}.

Thus, the shift amount corresponding to each direction component is specified by mvd_dequant_flag configured for each prediction block.

Another example of the derivation of blockSVer and blockSHor will be described with reference to FIG. 28B. FIG. 28B is a diagram illustrating an example of derivation of blockSVer and blockSHor. As illustrated in FIG. 28B, the inter prediction parameter decoding control unit 3031 decodes mvd_dequant_flag from the coded data by a difference vector unit or the like, and derives blockSHor and blockSVer based on mvd_dequant_flag. The inter prediction parameter decoding control unit 3031 determines whether the value of mvd_dequant_flag is other than 0 (S303421). In a case that mvd_dequant_flag is other than 0 (Y in S303421), the inter prediction parameter decoding control unit 3031 derives blockSHor=3 and blockSVer=2 (S303422) and the processing proceeds to S30343. In a case that mvd_dequant_flag is 0 (N in S303421), the inter prediction parameter decoding control unit 3031 derives blockSHor=1 and blockSVer=0 and the processing proceeds to S30343.

Next, the inter prediction parameter decoding control unit 3031 derives shiftSHor, which is shiftS for the horizontal component of the difference vector, and shiftSVer, which is shiftS for the vertical component of the difference vector (S30343). Specifically, the inter prediction parameter decoding control unit 3031 adds blockSHor or blockSVer to addS (shiftSHor=blockSHor+addS, shiftSVer=blockSVer+addS) to derive shiftSHor and shiftSVer.

Next, the inter prediction parameter decoding control unit 3031 dequantizes a syntax (horizontal component) mvdAbsVal[0] which indicates an absolute value of a horizontal motion vector difference, and a syntax (vertical component) mvdAbsVal[1] which indicates an absolute value of a vertical motion vector difference (S30344). Since the processing of S30344 is the same as S30334, the description thereof will be omitted.

As a result of the processing described above, the accuracy of the vertical component of the dequantized difference vector may be ½ pixel accuracy or 2 pixel accuracy, and the accuracy of the horizontal component of the dequantized difference vector may be 1 pixel accuracy or 4 pixel accuracy.

The accuracy of the vertical component of the dequantized difference vector may be 1 pixel accuracy or ¼ pixel accuracy, and the accuracy of the horizontal component of the dequantized difference vector may be 2 pixel accuracy or ½ pixel accuracy.

### Further Examples of Differential Vector Deriving Processing for Switching Signal Accuracy of Horizontal Component and Vertical Component of Differential Vector

The following processing may be performed in S30342 in FIGS. 28A and 28B.

The inter prediction parameter decoding control unit 3031 derives blockSVer and blockSHor for the horizontal component and the vertical component of the difference vector as different values (S30342). For example, the inter prediction parameter decoding control unit 3031 uses shiftSTb1Ver and shiftSTb1Hor, which are tables for deriving blockSVer and blockSHor (blockSVer=shiftSTb1Ver [mvd_dequant_flag], blockSHor=shiftSTb1Hor [mvd_dequant_flag]).

For example, shiftSTb1Ver [ ] may be {0, 2, 4} and shiftSTb1Hor [ ] may be {1, 3, 5}.

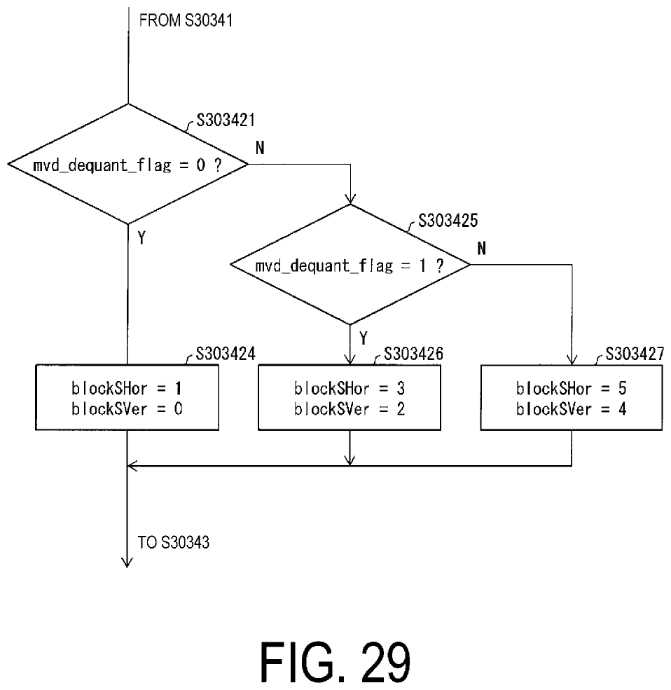

Another example of derivation of blockSVer and blockSHor will be described with reference to FIG. 29. FIG. 29 is a diagram illustrating an example of derivation of blockSVer and blockSHor.

As illustrated in FIG. 29, the inter prediction parameter decoding control unit 3031 decodes mvd_dequant_flag from the coded data by a difference vector unit or the like, and derives blockSHor and blockSVer based on mvd_dequant_flag. The inter prediction parameter decoding control unit 3031 determines whether the value of mvd_dequant_flag is 0 (S303421), In a case that mvd_dequant_flag is 0 (Y in S303421), the inter prediction parameter decoding control unit 3031 derives blockSHor=1 and blockSVer=0 and the processing proceeds to S30343. In a case that mvd_dequant_flag is not 0 (N in S303421), the inter prediction parameter decoding control unit 3031 determines whether the value of mvd_dequant_flag is 1 (S303425). In a case that mvd_dequant_flag is 1 (Y in S303425), the inter prediction parameter decoding control unit 3031 derives blockSHor=3 and blockSVer=2 (S303426) and the processing proceeds to S30343. In a case that mvd_dequant_flag is not 1 (S303425 N), the inter prediction parameter decoding control unit 3031 derives blockSHor=5 and blockSVer=4 (S303427) and the processing proceeds to S30343.

As a result of the processing described above, the accuracy of the vertical component of the dequantized difference vector may be 4 pixel accuracy, 1 pixel accuracy, or ¼ pixel accuracy, and the accuracy of the horizontal component of the dequantized difference vector may be 8 pixel accuracy, 2 pixel accuracy, or ½ pixel accuracy.

Another example of the accuracy of the vertical component and the accuracy of the horizontal component of the dequantized difference vector will be described. The value of the accuracy of the vertical component and the accuracy of the horizontal component of the dequantized difference vector is incremented by a factor of four between stages in the example described above. On the other hand, in the present example, the value of the accuracy of the vertical component and the accuracy of the horizontal component is not necessarily incremented by a factor of four between stages. The accuracy of the vertical component of the dequantized difference vector and the accuracy of the horizontal component may be configured to be 1 pixel accuracy. For example, in S30342 illustrated in FIG. 28A, with shiftSTb1Ver [ ] {0, 3} and shiftSTb1Hor [ ]={1, 3}, the accuracy of the vertical component of the dequantized difference vector may be 2 pixel accuracy or ¼ pixel accuracy, and the accuracy of the horizontal component of the dequantized difference vector may be 2 pixel accuracy or ½ pixel accuracy.

Also, in S30342 illustrated in FIG. 28A, with shiftSTb1Ver [ ]={0, 2}, and shiftSTb1Hor={1, 2}, the accuracy of the vertical component of the dequantized. difference vector may be 1 pixel accuracy or ¼ pixel accuracy, and the accuracy of the horizontal component of the dequantized difference vector may be 1 pixel accuracy or ½ pixel accuracy.

Also, in S30342 illustrated in FIG. 28A, with shiftSTb1Ver [ ]={0, 3, 4} and shiftSTb1Hor [ ]={1, 3, 5}, the accuracy of the vertical component of the dequantized difference vector may be 4 pixel accuracy, 2 pixel accuracy, or ¼ pixel accuracy, and the accuracy of the horizontal component of the dequantized difference vector may be 8 pixel accuracy, 2 pixel accuracy, or ½ pixel accuracy.

### Switching Vector Signaling Accuracy Based on Position of Prediction Block in Target Picture

In a VR image (in particular, an equirectangular image), the position at which the picture is enlarged is determined based on the position of the picture. At the position where the picture is enlarged, the motion vector of the prediction block is relatively large. Thus, the accuracy of the motion vector is not required to be high.

The inter prediction parameter decoding control unit 3031 according to the present example switches the accuracy of the motion vector of the prediction block in accordance with the position of the prediction block in the target picture. For example, in a prediction block in the vicinity of a pole (a Y coordinate in a target picture is around 0, or around pie height (height of the target picture)) in an equirectangular image, the accuracy of the motion vector is reduced. In a prediction block in the vicinity of the equator (the Y coordinate in the target picture is around pie height/2), the accuracy of the motion vector is increased.

In other words, the inter prediction parameter decoding control unit 3031 shifts the difference vector using the shift amount corresponding to the position of the prediction block in the reference image.

Furthermore, the shift amount may be larger in a case that the prediction block is positioned between a first predetermined height and a second predetermined height in the reference image than in a case that the prediction block is not positioned between the first predetermined height and the second predetermined height in the reference image.

According to the above-described configuration, the image coding apparatus 11 can efficiently code large motion vectors of prediction blocks located near the pole of the target picture. Therefore, the performance of the image coding apparatus 11 can be improved.

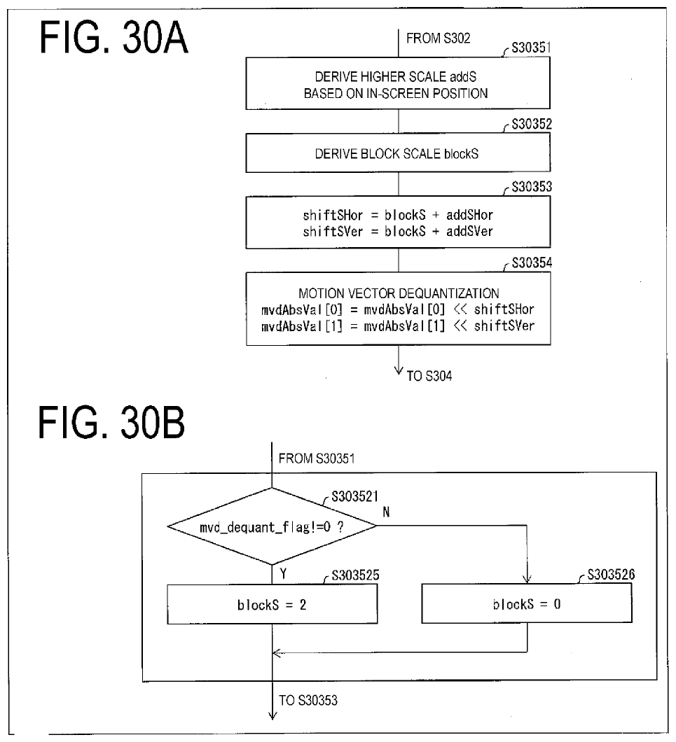

Next, with reference to FIGS. 30A and 30B, an example of difference vector deriving processing performed by the inter prediction parameter decoding control unit 3031 for switching the signaling accuracy of the difference vector based on the position of the prediction block in the target picture will be described. FIG. 30A is a flowchart illustrating an example of difference vector deriving processing in step S303.

As illustrated in FIGS. 30A and 30B, the inter prediction parameter decoding control unit 3031 derives a higher scale (S30351). For example, the inter prediction parameter decoding control unit 3031 derives addSVer, which is addS for the vertical component of the difference vector, as 0. The inter prediction parameter decoding control unit 3031 derives addSHor, which is addS for the horizontal component of the difference vector, as follows. In a case that the y-coordinate of the prediction block in the target picture is smaller than pic_height/4 or is greater than 3*pic_height/4, the inter prediction parameter decoding control unit 3031 derives addSHor as 2. In a case that the y-coordinate of the prediction block in the target picture is outside the range described above, the inter prediction parameter decoding control unit 3031 derives addSHor as 1.

Thus, addSHor=2 (y<pic_height/4), addSHor=2 (y>3*pic_height/4), and addSHor=1 (outside of the above range) hold true.

Next, the inter prediction parameter decoding control unit 3031 derives the block scale blockS (S30352). Specifically, the inter prediction parameter decoding control unit 3031 decodes mvd_dequant_flag in a difference vector unit, or the like. Here, the table shiftSTb1 may be used and blockS is derived by blockS=shiftSTb1 [mvd_dequant_flag]. Note that blockS may be common between the horizontal component and the vertical component of the difference vector.

For example, with shiftSTb1={0, 2}, blockS is 0 in a case that the value of mvd_dequant_flag is 0, and is 2 in a case that mvd_dequant_flag is 1. Another example of derivation of blockS will be described with reference to FIG. 30B. FIG. 30B is a diagram illustrating an example of derivation of the block scale blockS. As illustrated in FIG. 30B, the inter prediction parameter decoding control unit 3031 decodes mvd_dequant_flag from the coded data by a difference vector unit or the like, and derives blockS based on mvd_dequant_flag. The inter prediction parameter decoding control unit 3031 determines whether the value of mvd_dequant_flag is other than 0 (S303521). In a case that mvd_dequant_flag is other than 0 (V in S303521), the inter prediction parameter decoding control unit 3031 derives blockS=2 (S303525) and the processing proceeds to S30353. In a case that mvd_dequant_flag is 0 (N in S303521), the inter prediction parameter decoding control unit 3031 derives blockS=0 (303526) and the processing proceeds to S30353.

Next, the inter prediction parameter decoding control unit 3031 derives shiftSHor, which is shiftS for the horizontal component of the difference vector, and shiftSVer, which is shiftS for the vertical component of the difference vector (S30353). Specifically, the inter prediction parameter decoding control unit 3031 adds addSHor or addSVer to blockS (shiftSHor=blockS+addSHor, shiftSVer=blockS+addSVer) to derive shiftSHor and shiftSVer.

Next, the inter prediction parameter decoding control unit 3031 dequantizes a syntax (horizontal component) mvdAbsVal[0], which indicates an absolute value of a horizontal motion vector difference and a syntax (vertical component) mvdAbsVal[1], which indicates an absolute value of a vertical motion vector difference (S30354). Since the processing of S30344 is the same as S30334, the description thereof will be omitted.

With the processing described above, the pixel accuracy of the horizontal component of the motion vector of the prediction block near the equator of the target image may be set to 2 pixel accuracy or ½ pixel accuracy, and the pixel accuracy of the horizontal component of the motion vector of the prediction block near the pole may be 4 pixel accuracy or 1 pixel accuracy.

### Other Example of Switching Movement Vector Signaling Accuracy Based on Position of Prediction Block in Target Picture

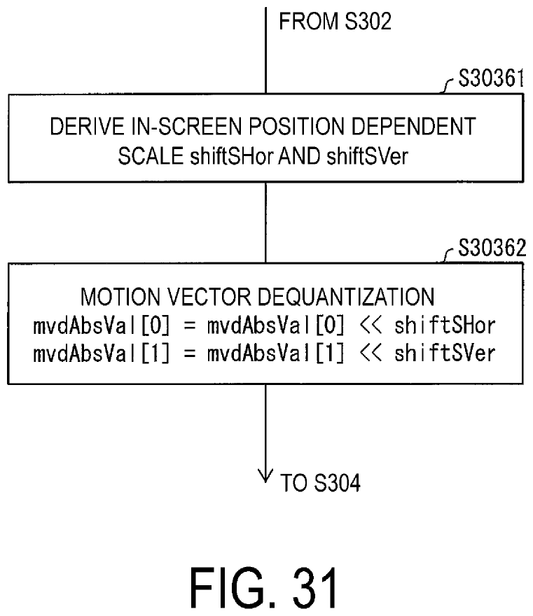

Another example of a difference vector derivation process is described with reference to FIG. 31. FIG. 31 is a flowchart specifically illustrating another example of the difference vector deriving processing in step S303.

As illustrated in FIG. 31, the inter prediction parameter decoding control unit 3031 derives shiftSHor and shiftS Vert, the scale dependent on the position in the picture, for the horizontal component and the vertical component of the difference vector based on the position of the prediction block in the picture (S30361). For example, the inter prediction parameter decoding control unit 3031 derives shiftSVert for the vertical component of the difference vector as 0. The inter prediction parameter decoding control unit 3031 derives shiftSHor for the horizontal component of the difference vector as follows. In a case that the y-coordinate of the prediction block in the target picture is smaller than pic_height/4 or the y-coordinate of the prediction block in the target picture is greater than 3*pic_height/4, the inter prediction parameter decoding control unit 3031 derives shiftSHor as 1. In a case that the y-coordinate of the prediction block in the target picture is outside the range described above, the inter prediction parameter decoding control unit 3031 derives shiftSHor as 0.

Thus, shiftSHor=1 (y<pic_height/4), shiftSHor=1 (y>3*pic_height/4), and shiftSHor=0 (outside of the above range) hold true.

Next, the inter prediction parameter decoding control unit 3031 dequantizes a syntax (horizontal component) mvdAbsVal[0] indicating an absolute value of a horizontal motion vector difference, and a syntax (vertical component) mvdAbsVal[1], which indicates an absolute value of a vertical motion vector difference (S30362). Since the processing of S30362 is the same as S30334, the description thereof will be omitted.

As a result of the processing described above, the pixel accuracy of the component in the vertical direction of the motion vector of the prediction block may be ¼ pixel accuracy. In a case that the y-coordinate of the prediction block in the target picture is smaller than pic_height/4 or the y-coordinate of the prediction block in the target picture is greater than 3*pic_height/4, the pixel accuracy of the horizontal component of the motion vector of the prediction block may be ½ pixel accuracy. In a case that the y-coordinate of the prediction block in the target picture is outside the range described above, the pixel accuracy of the horizontal component of the motion vector of the prediction block may be ¼ pixel accuracy.

### Another Example of Motion Vector

Another example of shiftSVer and shiftSHor that are derived by the inter prediction parameter decoding control unit 3031 will be described, in S30361 in FIG. 31, the inter prediction parameter decoding control unit 3031 may derive shiftSVer and shiftSHor as follows, The inter prediction parameter decoding control unit 3031 derives shiftSVer as 0.

In a case that the y-coordinate of the prediction block in the target picture is smaller than pic_height/8 or the y-coordinate of the prediction block in the target picture is greater than 7*pic_height/8, the inter prediction parameter decoding control unit 3031 derives shiftSHor as 2.

In a case that the y-coordinate of the prediction block in the target picture is smaller than pic_height/4 and equal to or greater than pic_height/8, and in a case that the y-coordinate of the prediction block in the target picture is greater than 3*pic_height/4 and is equal to or less than 7*pic_height/8, the inter prediction parameter decoding control unit 3031 derives shiftSHor as 1.

In a case that the y-coordinate of the prediction block in the target picture is outside the range described above, the inter prediction parameter decoding control unit 3031 derives shiftSHor as 0.

Specifically, the derivation is summarized as follows.
shiftSVer=0
shiftSHor=2 (y<pic_height/8)
shiftSHor=1 (y<pic_height/4 & & y>=pic_height/8)
shiftSHor=1 (y>3*pic_height/4 & & y<=7*pic_height/8)
shiftSHor=2 (y>7*pic_height/8)
shiftSHor=0 (outside of the above range)

As a result of the processing described above, the pixel accuracy of the component in the vertical direction of the motion vector of the prediction block may be ¼ pixel accuracy.

In a case that the y-coordinate of the prediction block in the target picture is smaller than pic_height/8 or the y-coordinate of the prediction block in the target picture is greater than 7*pic_height/8, the inter prediction parameter decoding control unit 3031 may configure the 1 pixel accuracy of the horizontal component of the motion vector.

Also, in a case that the y-coordinate of the prediction block in the target picture is smaller than pic_height/4 and equal to or greater than pic_height/8, and the y-coordinate of the prediction block in the target picture is greater than 3*pic_height/4 and is equal to or less than 7*pic_height/8, the inter prediction parameter decoding control unit 3031 may configure the pixel accuracy of the horizontal component of the motion vector to be the ½ pixel accuracy.

In a case that the y-coordinate of the prediction block in the target picture is outside the range described above, the inter prediction parameter decoding control unit 3031 configures the pixel accuracy of the horizontal component of the motion vector to ¼ pixel accuracy.

Note that the inter prediction parameter decoding control unit 3031 may be configured to derive the movement accuracy flags addSVer and addSHor based on the position in the picture, and decode the blockS decoded from the coded data by a difference vector unit, or the like.
addSVer=0
addSHor=2 (y<pic_height/8)
addSHor=1 (y<pic_height/4 & & y>pic_height/8)
addSHor=1 (y>3*pic_height/4 & & y<=7*pic_height/8)
addSHor=2 (y>7*pic_height/8)
addSHor=0 (outside of the above range)

In the case of this configuration, the inter prediction parameter decoding control unit 3031 derives shiftSHor and shiftSVer based on addSHor, addSver, and blockS.
shiftSHor=blockS+addSHor
shiftSVer=blockS+addSVer

In this configuration, as a result of the processing described above, the pixel accuracy of the component in the vertical direction of the motion vector of the prediction block may be ¼ pixel accuracy.

In a case that the y-coordinate of the prediction block in the target picture is smaller than pic_height/8 or the y-coordinate of the prediction block in the target picture is greater than 7*pic_height/8, the inter prediction parameter decoding control unit 3031 may configure the pixel accuracy of the horizontal component of the motion vector to be 4 or 1 pixel accuracy.

In a case that the y-coordinate of the prediction block in the target picture is smaller than pic height/4 and is equal to or greater than pie height/8, and the y-coordinate of the prediction block in the target picture is greater than 3*pic_height/4 and equal to or less than 7*pic_height/8, the inter prediction parameter decoding control unit 3031 may configure the pixel accuracy of the horizontal component of the motion vector to be 2 or ½ pixel accuracy

In a case that the y-coordinate of the prediction block in the target picture is outside the range described above, the inter prediction parameter decoding control unit 3031 configure pixel accuracy of the horizontal component of the motion vector to be the 1 or ¼ pixel accuracy.

### Further Example of Accuracy of Motion Vector

A further example of shiftSVer and shiftSHor that are derived by the inter prediction parameter decoding control unit 3031 will be described. In S30361 in FIG. 31, the inter prediction parameter decoding control unit 3031 may derive shiftSVer and shiftSHor as follows.

In a case that the y-coordinate of the prediction block in the target picture is smaller than pic_height/8 or the y-coordinate of the prediction block in the target picture is greater than 7*pic_height/8, the inter prediction parameter decoding control unit 3031 derives shiftSVer derives shiftSHor as 2.

Also, in a case that the y-coordinate of the prediction block in the target picture is smaller than pic_height/4 and greater than or equal to pic_height/8, and in a case that the y-coordinate of the prediction block in the target picture is greater than 3*pic height/4 and is equal to or less than 7*pic_height/8, the inter prediction parameter decoding control unit 3031 derives shiftSVer as 0 and derives shiftSHor as 1.

In a case that the y-coordinate of the prediction block in the target picture is outside the range described above, the inter prediction parameter decoding control unit 3031 derives shiftSVer and shiftSHor as 0.
i.e.
shiftSVer==1
shiftSHor=2 (y<pic_height/8)
shiftSVer=0, shiftSHor=1 (y<pic_height/4 & & y>=pic_height/8)
shiftSVer=0, shiftSHor=1 (y>3*pic_height/4 & & y<=7*pic_height/8
shiftSVer=1, shiftSHor=2 (y>7*pic_height/8)
shiftSVer=0, shiftSHor=0 (outside of the above range)
   is the result.

In a case that the y-coordinate of the prediction block in the target picture is less than pic_height/8, the inter prediction parameter decoding control unit 3031 may have ½ pixel accuracy of the pixel accuracy of the vertical component of the motion vector.

In a case that the y-coordinate of the prediction block in the target picture is greater than 7*pic_height/8, the inter prediction parameter decoding control unit 3031 may have ½ pixel accuracy of the pixel accuracy of the component in the vertical direction of the motion vector.

In a case that the y-coordinate of the prediction block in the target picture is outside the range described above, the inter prediction parameter decoding control unit 3031 may have ¼ pixel accuracy of pixel accuracy of the vertical component of the motion vector.

In a case that the y-coordinate of the prediction block in the target picture is less than pic_height/8, the inter prediction parameter decoding control unit 3031 may have 1 pixel accuracy of the horizontal component of the motion vector.

In a case that the y-coordinate of the prediction block in the target picture is smaller than pic_height/4 and greater than or equal to pic_height/8, the inter prediction parameter decoding control unit 3031 may have ½ pixel accuracy of the pixel accuracy of the horizontal component of the motion vector.

In a case that the y-coordinate of the prediction block in the target picture is greater than 3*pic_height/4 and is equal to or less than 7*pic_height/8, the inter prediction parameter decoding control unit 3031 may have ½ pixel accuracy of the pixel accuracy of the horizontal component of the motion vector.

Additionally, in a case that the y-coordinate of the prediction block in the target picture is greater than 7*pic_height/8, the inter prediction parameter decoding control unit 3031 may have 1 pixel accuracy of the horizontal component of the motion vector.

In a case that the y-coordinate of the prediction block in the target picture is outside the range described above, the inter prediction parameter decoding control unit 3031 may have ¼ pixel accuracy of pixel accuracy of the vertical component of the motion vector.

Note that the inter prediction parameter decoding control unit 3031 may be configured to derive the movement accuracy flags addSVer and addSHor based on the position in the picture, and decode the blockS decoded from the coded data by a difference vector unit, or the like.
addSVer=1, addSHor=2 (y<pic_height/8)
addSVer=0, addSHor=1 (y<pic_height/4 & & y>=pic_height/8)
addSVer=0, addSHor=1 (y>3*pic_height/4 & & y<=7*pic_height/8)
addSVer=1, addSHor=2 (y>7*pic_height/8)
addSVer=0, addSHor=0 (outside of the above range)

In the case of this configuration, the inter prediction parameter decoding control unit 3031 derives shiftSHor and shiftSVer based on addSHor, addSVer, and blockS.
shiftSHor=blockS+addSHor
shiftSVer=blockS+addSVer

In a case that the y-coordinate of the prediction block in the target picture is less than pic_height/8, the inter prediction parameter decoding control unit 3031 may have ½ pixel accuracy of the pixel accuracy of the vertical component of the motion vector.

In a case that the y-coordinate of the prediction block in the target picture is greater than 7*pic_height/8, the inter prediction parameter decoding control unit 3031 may have 2 or ½ pixel accuracy of the pixel accuracy of the component in the vertical direction of the motion vector.

In a case that y-coordinate of the prediction block in the target picture is outside the range described above, the inter prediction parameter decoding control unit 3031 may have 1 or ¼ pixel accuracy of pixel accuracy of the vertical component of the motion vector.

In a case that the y-coordinate of the prediction block in the target picture is less than pic_height/8, the inter prediction parameter decoding control unit 3031 may have 4 or 1 pixel accuracy of the horizontal component of the motion vector.

In a case that the y-coordinate of the prediction block in the target picture is smaller than pic_height/4 and greater than or equal to pic_height/8, the inter prediction parameter decoding control unit 3031 may have 2 or ½ pixel accuracy of the pixel accuracy of the horizontal component of the motion vector.

In a case that the y-coordinate of the prediction block in the target picture is greater than 3*pic_height/4 and is equal to or less than 7*pic_height/8, the inter prediction parameter decoding control unit 3031 may have 2 or ½ pixel accuracy of the pixel accuracy of the horizontal component of the motion vector.

Additionally, in a case that the y-coordinate of the prediction block in the target picture is greater than 7*pic_height/8, the inter prediction parameter decoding control unit 3031 may have 4 or 1 pixel accuracy of the horizontal component of the motion vector.

In a case that the y-coordinate of the prediction block in the target picture is outside the range described above, the inter prediction parameter decoding control unit 3031 may have 1 or ¼ pixel accuracy of pixel accuracy of the vertical component of the motion vector.

### Other Example of Switching Movement Vector Signaling Accuracy Based on Position of Prediction Block in Target Picture

In this example, an example is given of a case in which the target picture is applied to an image in which an image on a spherical surface is projected onto a spherical surface or a cube. In this example, in particular, the target picture applied to the cube mapping that projects the image on the spherical surface to a cube is illustrated. The inter prediction parameter decoding control unit 3031 codes the target picture projected on each face of the cube (six surfaces of a square) and codes the target picture as a single frame.

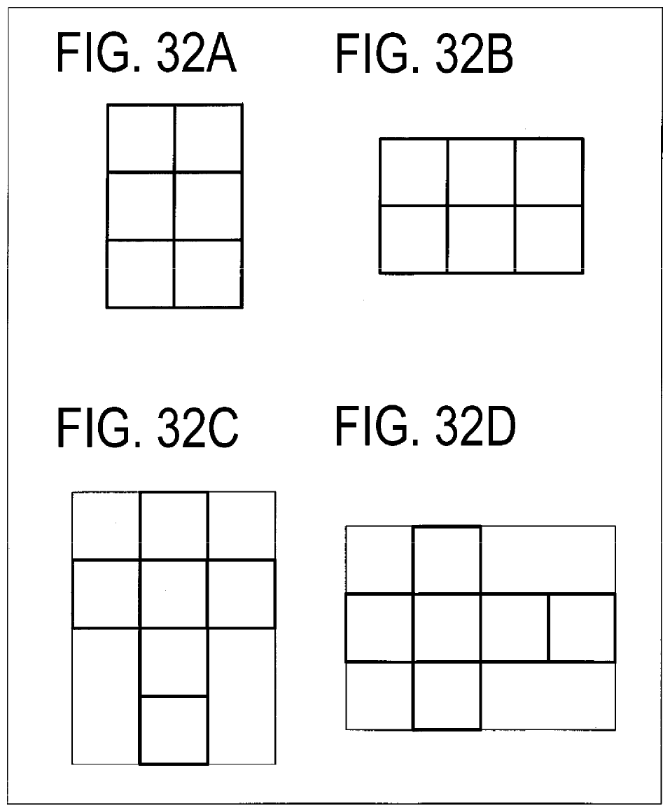

FIGS. 32A to 32D are diagrams illustrating an example of a frame of a target picture. FIGS. 32A and 329 illustrate examples in which images projected on each surface of a cube are a rectangular frame with no gaps in 2×3, 3×2 (images projected on each side of a cube may be arranged in 6×1, 1×6). FIGS. 32C and 32D illustrate examples in which each face of a cube fills an undeployed region by padding, such that the cube is expanded to form a rectangular frame that contains images projected on each surface (4×3 frames or 3×4). Padding may be performed by tilling with a specific value (for example, gray), or may be performed by filling a value by copying the value of another surface horizontally or vertically.

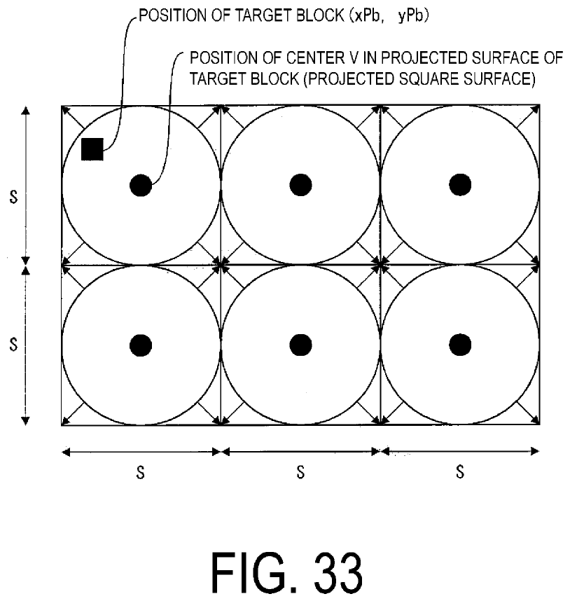

Next, the enlargement of an image projected onto each surface of a cube is described with reference to FIG. 33. FIG. 33 is a diagram illustrating enlargement of an image projected on each surface of a cube. The arrows in FIG. 33 indicate the direction of enlargement of the image projected on each surface of the cube. The cube mapping is stretched from the points on the circumference in the circular image, near the vertices of the squares on each side of the cube as shown in FIG. 33.

As illustrated in FIG. 33, the position of the target prediction block is (xPb, yPb), and the position of the center V of the surface on which the target prediction block is projected (projected square surface) is (xVt, yVt). The width and height of each surface of the cube is S.

Next, an example of difference vector deriving processing performed by the inter prediction parameter decoding control unit 3031 for switching the signaling accuracy of the difference vector based on the position of the prediction block in the target picture according to the present example will be described.

In the process, as illustrated in FIG. 31, the inter prediction parameter decoding control unit 3031 derives shiftSHor and shiftSVer, the scale dependent on the position in the picture, for the horizontal component and the vertical component of the difference vector, based on the position of the prediction block in the picture (S30361). in the processing, the inter prediction parameter decoding control unit 3031 derives shiftSVer and shiftSHor based on the distance between the position (xPb, yPb) of the target block and the center position (xVt, yVt) of the surface of the cube onto which the target block is projected. Specifically, in a case that the distance between the position (xPb, yPb) of the target block and the center position (xVt, yVt) of the surface of the cube exceeds the width and height S of the projection surface, the inter prediction parameter decoding control unit 3031 derives shiftSVer and shiftSHor as large values.

For example, the inter prediction parameter decoding control unit 3031 may derive shiftSVer and shiftSHor according to the following equation.

diff=|xPb−xVt|̂2+|yPb−yVt|̂2
if (diff>S*S)
   shiftSHor=1
   shiftSVer=1
else
   shiftSHor=0
   shiftSVer=0

For example, the distance between the location of the target block (xPb, yPb) and the center position (xVt, yVt) of the surface of the cube may be the Euclidean distance, or may be a city block distance. In this case, the inter prediction parameter decoding control unit 3031 derives shiftSVer and shiftSHor according to the following equation.

diff=|xPb−xVt|+|yPb−yVt|
if (diff≤S)
   shiftSHor=1
   shiftSVer=1
else
   shiftSHor=0
   shiftSVer=0

Next, the inter prediction parameter decoding control unit 3031 dequantizes a syntax (horizontal component) mvdAbsVal[0] indicating an absolute value of a horizontal motion vector difference, and a syntax (vertical component) mvdAbsVal[1], which indicates an absolute value of a vertical motion vector difference (S30362). Since the processing of S30362 is the same as S30334, the description thereof will be omitted.

In other words, the inter prediction parameter decoding control unit 3031 shifts the difference vector using the shift amount corresponding to the distance between the position of the prediction block and the center position of the plane of the projected cube.

### Configuration of Image Coding Apparatus

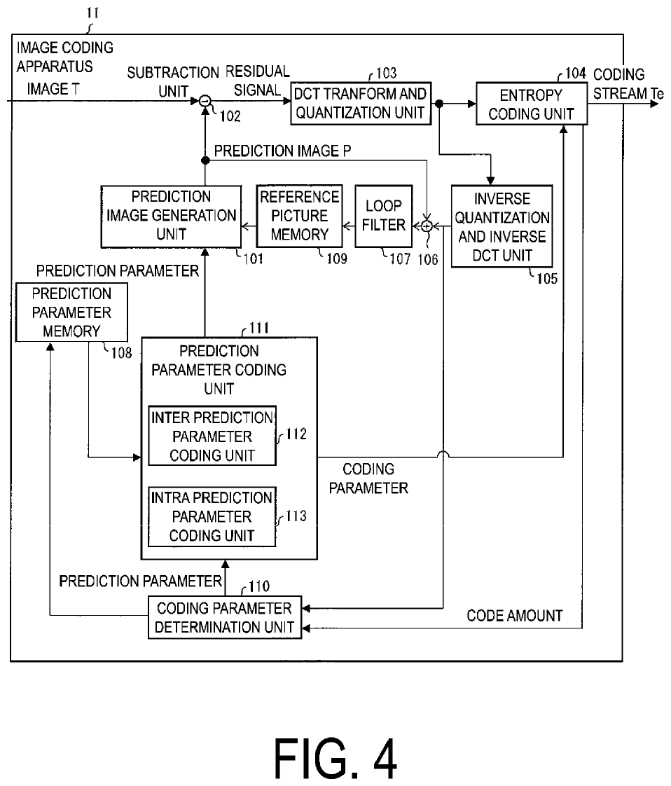

A configuration of the image coding apparatus 11 according to the present embodiment will now be described. FIG. 4 is a block diagram illustrating a configuration of the image coding apparatus 11 according to the present embodiment. The image coding apparatus 11 is configured to include a prediction image generation unit 101, a subtraction unit 102, a DCT and quantization unit 103, an entropy coding unit 104, an dequantization and inverse DCT unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, and a prediction parameter coding unit 111. The prediction parameter coding unit ill is configured to include an inter prediction parameter coding unit 112 and an intra prediction parameter coding unit 113.

For each picture of an image T, the prediction image generation unit 101 generates a prediction image P of a prediction unit PU for each coding unit CU that is a region where the picture is split. Here, the prediction image generation unit 101 reads a block that has been decoded from the reference picture memory 109, based on a prediction parameter input from the prediction parameter coding unit 111. For example, in a case of an inter prediction, the prediction parameter input from the prediction parameter coding unit 111 is a motion vector. The prediction image generation unit 101 reads a block in a position in a reference image indicated by a motion vector starting from a target PU. In a case of an intra prediction, the prediction parameter is, for example, an intra prediction mode. The prediction image generation unit 101 reads a pixel value of an adjacent PU used in an intra prediction mode from the reference picture memory 109, and generates the prediction image P of a PU. The prediction image generation unit 101 generates the prediction image P of a PU using one prediction scheme among multiple prediction schemes for the read reference picture block. The prediction image generation unit 101 outputs the generated prediction image P of a PU to the subtraction unit 102.

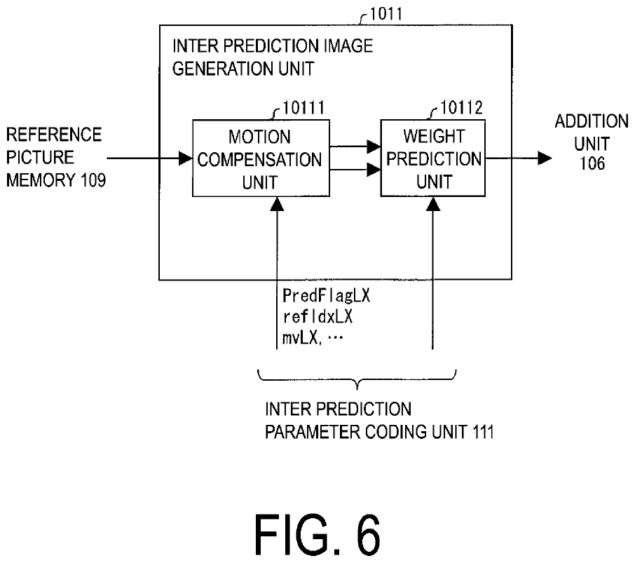

Note that the prediction image generation unit 101 is an operation same as the prediction image generation unit 308 already described. For example, FIG. 6 is a schematic diagram illustrating a configuration of the inter prediction image generation unit 1011 included in the prediction image generation unit 101. The inter prediction image generation unit 1011 is configured to include a motion compensation unit 10111 and a weight prediction unit 10112. Descriptions about the motion compensation unit 10111 and the weight prediction unit 10112 are omitted since the motion compensation unit 10111 and the weight prediction unit 10112 have configurations similar to each of the above-mentioned motion compensation unit 3091 and weight prediction unit 3094, respectively.

The prediction image generation unit 101 generates the prediction image P of a PU based on a pixel value of a reference block read from the reference picture memory by using a parameter input by the prediction parameter coding unit. The prediction image generated by the prediction image generation unit 101 is output to the subtraction unit 102 and the addition unit 106.

The subtraction unit 102 subtracts a signal value of the prediction image P of a PU input from the prediction image generation unit 101 from a pixel value of a corresponding PU of the image T, and generates a residual signal. The subtraction unit 102 outputs the generated residual signal to the DCT and quantization unit 103.

The DCT and quantization unit 103 performs a DCT for the residual signal input from the subtraction unit 102, and calculates DCT coefficients. The DCT and quantization unit 103 quantizes the calculated DCT coefficients to calculate quantization coefficients. The DCT and quantization unit 103 outputs the calculated quantization coefficients to the entropy coding unit 104 and the dequantization and inverse DCT unit 105.

To the entropy coding unit 104, quantization coefficients are input from the DCT and quantization unit 103, and coding parameters are input from the prediction parameter coding unit 111. For example, input coding parameters include codes such as a reference picture index refIdxLX, a prediction vector index mvp_LX_idx, a difference vector mvdLX, a prediction mode predMode, and a merge index merge_idx.

The entropy coding unit 104 entropy codes the input quantization coefficients and coding parameters to generate the coding stream Te, and outputs the generated coding stream Te to the outside.

The dequantization and inverse DCT unit 105 dequantizes the quantization coefficients input from the DCT and quantization unit 103 to calculate DCT coefficients. The dequantization and inverse DCT unit 105 performs inverse DCT on the calculated DCT coefficient to calculate residual signals. The dequantization and inverse DCT unit 105 outputs the calculated residual signals to the addition unit 106.

The addition unit 106 adds signal values of the prediction image P of the PUs input from the prediction image generation unit 101 and signal values of the residual signals input from the dequantization and inverse DCT unit 105 for every pixel, and generates the decoded image. The addition unit 106 stores the generated decoded image in the reference picture memory 109.

The loop filter 107 performs a deblocking filter, a sample adaptive offset (SAO), and an adaptive loop filter (ALF) to the decoded image generated by the addition unit 106.

The prediction parameter memory 108 stores the prediction parameters generated by the coding parameter determination unit 110 for every picture and CU of the coding target in a prescribed position.

The reference picture memory 109 stores the decoded image generated by the loop filter 107 for every picture and CU of the coding target in a prescribed position.

The coding parameter determination unit 110 selects one set among multiple sets of coding parameters. A coding parameter is the above-mentioned prediction parameter or a parameter to be a target of coding generated associated with the prediction parameter. The prediction image generation unit 101 generates the prediction image P of the PUs using each of the sets of these coding parameters.

The coding parameter determination unit 110 calculates cost values indicating a volume of an information quantity and coding errors for each of the multiple sets. For example, a cost value is a sum of a code amount and a value of multiplying a coefficient λ by a square error. The code amount is an information quantity of the coding stream Te obtained by entropy coding a quantization error and a coding parameter. The square error is a sum total of pixels for square values of residual values of residual signals calculated in the subtraction unit 102. The coefficient λ is a real number that is larger than a pre-configured zero. The coding parameter determination unit 110 selects a set of coding parameters by which the calculated cost value is minimized. With this configuration, the entropy coding unit 104 outputs the selected set of coding parameters as the coding stream Te to the outside, and does not output sets of coding parameters that are not selected. The coding parameter determination unit 110 stores the determined coding parameters in the prediction parameter memory 108.

The prediction parameter coding unit 111 derives a format for coding from parameters input from the coding parameter determination unit 110, and outputs the format to the entropy coding unit 104. A derivation of a format for coding is, for example, to derive a difference vector from a motion vector and a prediction vector. The prediction parameter coding unit 111 derives parameters necessary to generate a prediction image from parameters input from the coding parameter determination unit 110, and outputs the parameters to the prediction image generation unit 101. For example, parameters necessary to generate a prediction image are a motion vector of a subblock unit.

The inter prediction parameter coding unit 112 derives inter prediction parameters such as a difference vector, based on prediction parameters input from the coding parameter determination unit 110. The inter prediction parameter coding unit 112 includes a partly identical configuration to a configuration by which the inter prediction parameter decoding unit 303 (see FIG. 5 and the like) derives inter prediction parameters, as a configuration to derive parameters necessary for generation of a prediction image output to the prediction image generation unit 101. A configuration of the inter prediction parameter coding unit 112 will be described below.

The intra prediction parameter coding unit 113 derives a format for coding (for example, MPM_idx, rem_intra_luma_pred_mode, and the like) from the intra prediction mode IntraPredMode input from the coding parameter determination unit 110.

### Inter Prediction Parameter Coding Unit

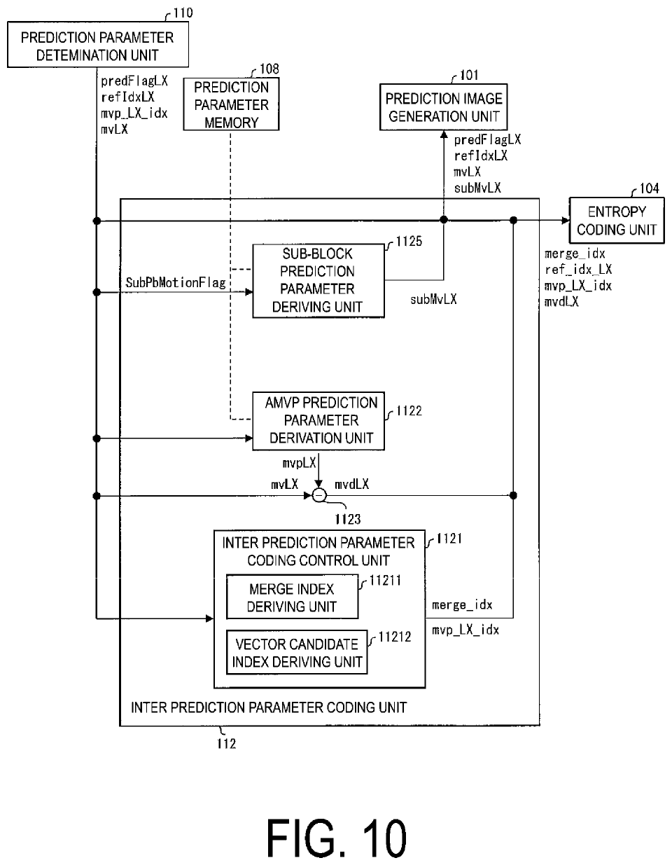

A configuration of the inter prediction parameter coding unit 112 will be described below. The inter prediction parameter coding unit 112 is a means corresponding to the inter prediction parameter decoding unit 303 in FIG. 12, a configuration thereof is illustrated in FIG. 10.

The inter prediction parameter coding unit 112 includes an inter prediction parameter coding control unit 1121, AMVP prediction parameter deriving unit 1122, a subtracting unit 1123, and a sub-block prediction parameter deriving unit 1125, as well as unillustrated components include a split mode derive unit, a merging flag deriving unit, an inter prediction identifier deriving unit, a reference picture index deriving unit, a vector difference deriving unit, and the like. The split mode deriving unit, the merging flag deriving unit, the inter prediction identifier deriving unit, the reference picture index deriving unit, and the vector difference deriving unit each derive a PU division mode part_mode, a merging flag merge_flag, an inter prediction identifier inter_pred_idc, a reference picture index refldxLX, and a difference vector mvdLX. The inter prediction parameter coding unit 112 outputs the motion vector (mvLX, subMvLX), the reference picture index refIdxLX, PU split mode part_mode, inter prediction identifier inter_pred_idc, or information indicating these to the prediction image generation unit 101. The inter prediction parameter coding unit 112 outputs a PU split mode part_mode, a merge flag merge_flag, a merge index merge_idx, an inter prediction indicator inter_pred_idc, a reference picture index refIdxLX, a prediction vector index mvp_LX_idx, and a difference vector mvdIA to the entropy coding unit 104.

The inter prediction parameter coding control unit 1121 includes a merging index deriving unit 11211 and a vector candidate index deriving unit 11212. The merging index deriving unit 11211 is configured to derivate a merging index merge_idx by comparing a motion vector and a reference picture index input from the coding parameter determining unit 110 with the motion vector and the reference picture index held by the PU of the merging candidates read from the prediction parameter memory 108 and outputs the index to the entropy coding unit 104. The merging candidate is a reference PU (for example, a reference PU in contact with the lower left, upper left, and right upper ends of the coding block) in a predetermined range from the coding subject CU to be coded, and is the PU on which the coding processing has been completed. The vector candidate index deriving unit 11212 derives the prediction vector index mvp_LX_idx.

In a case that the coding parameter determining unit 110 determines the use of the sub-block prediction mode, the sub-block prediction parameter deriving unit 1125 derives a motion vector and a reference picture index for sub-block prediction of any of spatial sub-block prediction, time sub-block prediction, affine prediction, and matching prediction based on the value of subPbMotionFlag. As described in the description of the image decoding apparatus, the motion vector and reference picture index such as such as motion vectors and reference picture indexes, such as neighboring PU and reference picture blocks are read out from the prediction parameter memory 108 to be derived.

The AMVP prediction parameter deriving unit 1122 has the same configuration as the AMVP prediction parameter deriving unit 3032 (see FIG. 12).

In other words, in a case that the prediction mode predMode indicates the inter prediction mode, the motion vector mvLX is input to the AMVP prediction parameter deriving unit 1122 from the coding parameter determining unit 110. The AMVP prediction parameter deriving unit 1122 derives the prediction vector mvpLX based on the input motion vector mvLX. The AMVP prediction parameter deriving unit 1122 outputs the derived prediction vector mvpLX to the subtracting unit 1123. Note that the reference picture index refldx and the prediction vector index mvp_LX_idx are output to the entropy coding unit 104.

The subtracting unit 1123 subtracts the prediction vector mvpLX input from the AMVP prediction parameter deriving unit 1122 from the motion vector mvLX input from the coding parameter determining unit 110, and to generates a difference vector mvdLX. The difference vector mvdLX is output to the entropy coding unit 104.

Note that, part of the image coding apparatus 11 and the image decoding apparatus 31 in the above-mentioned embodiments, for example, the entropy decoding unit 301, the prediction parameter decoding unit 302, the loop filter 305, the prediction image generation unit 308, the dequantization and inverse DCT unit 311, the addition unit 312, the prediction image generation unit 101, the subtraction unit 102, the DCT and quantization unit 103, the entropy coding unit 104, the dequanization and inverse DCT unit 105, the loop filter 107, the coding parameter determination unit 110, and the prediction parameter coding unit 111 may be realized by a computer. In that case, this configuration may be realized by recording a program for realizing such control functions on a computer-readable recording medium and causing a computer system to read the program recorded on the recording medium for execution. Note that it is assumed that the “computer system” mentioned here refers to a computer system built into either the image coding apparatus 11 or the image decoding apparatus 31, and the computer system includes an OS and hardware components such as a peripheral apparatus. Furthermore, the “computer-readable recording medium” refers to a portable medium such as a flexible disk, a magneto-optical disk, a ROM, a CD-ROM, and the like, and a storage apparatus such as a hard disk built into the computer system. Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Part or all of the image coding apparatus 11 and the image decoding apparatus 31 in the above-described embodiments may be realized as an integrated circuit such as a Large Scale Integration (LSI). Each function block of the image coding apparatus 11 and the image decoding apparatus 31 may be individually realized as processors, or part or all may be integrated into processors. The circuit integration technique is not limited to LSI, and the integrated circuits for the functional blocks may be realized as dedicated circuits or a multi-purpose processor. Furthermore, in a case that with advances in semiconductor technology, a circuit integration technology that replaces an LSI is introduced, an integrated circuit based on the technology may be used.

The embodiment of the disclosure has been described in detail above referring to the drawings, but the specific configuration is not limited to the above embodiments and various amendments can be made to a design that fall within the scope that does not depart from the gist of the disclosure.

### Application Examples

The above-mentioned image coding apparatus 11 and the image decoding apparatus 31 can be utilized being installed to various apparatuses performing transmission, reception, recording, and regeneration of videos. Note that, videos may be natural videos imaged by cameras or the like, or may be artificial videos (including CG and GUI) generated by computers or the like.

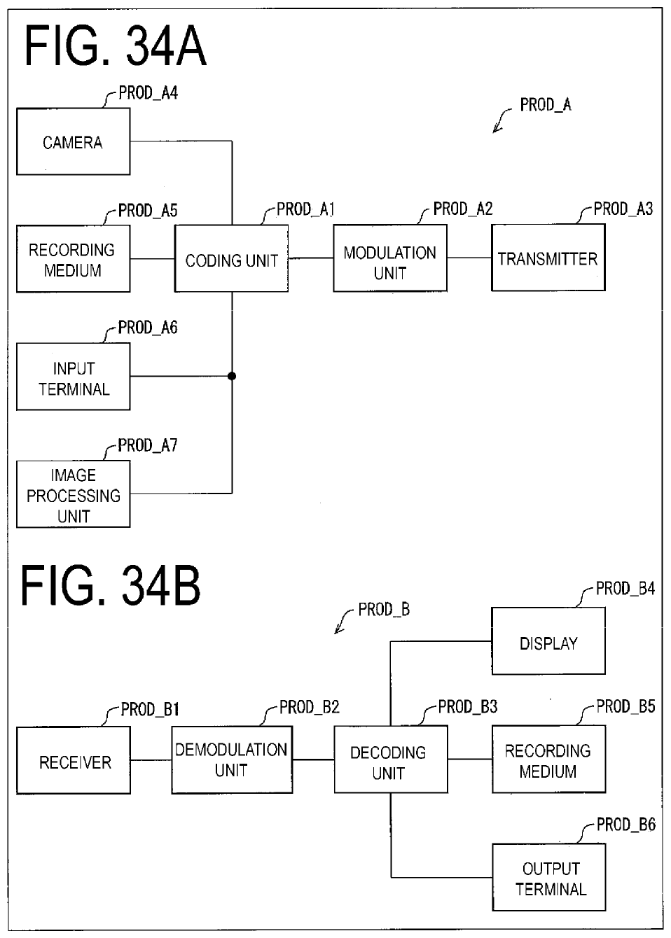

First, referring to FIGS. 34A and 34B, it will be described that the above-mentioned image coding apparatus 11 and the image decoding apparatus 31 can be utilized for transmission and reception of videos.

FIG. 34A is a block diagram illustrating a configuration of a transmitting apparatus PROD_A installed with the image coding apparatus 11. As illustrated in FIG. 34A, the transmitting apparatus PROD_A includes a coding unit PROD_A1 which obtains coded data by coding videos, a modulation unit PROD_A2 which obtains modulating signals by modulating carrier waves with the coded data obtained by the coding unit PROD_A1, and a transmitter PROD_A3 which transmits the modulating signals obtained by the modulation unit PROD_A2. The above-mentioned image coding apparatus 11 is utilized as the coding unit PROD_A1.

The transmitting apparatus PROD_A may further include a camera PROD_A4 imaging videos, a recording medium PROD_A5 recording videos, an input terminal PROD_A6 to input videos from the outside, and an image processing unit A7 which generates or processes images, as sources of supply of the videos input into the coding unit PROD_A1. In FIG. 34A, although the configuration that the transmitting apparatus PROD_A includes these all is exemplified, a part may be omitted.

Note that the recording medium PROD_A5 may record videos which are not coded, or may record videos coded in a coding scheme for record different than a coding scheme for transmission. In the latter case, a decoding unit (not illustrated) to decode coded data read from the recording medium PROD_A5 according to coding scheme for recording may be interleaved between the recording medium PROD_A5 and the coding unit PROD_A1.

FIG. 34B is a block diagram illustrating a configuration of a receiving apparatus PROD_B installed with the image decoding apparatus 31. As illustrated in FIG. 34B, the receiving apparatus PROD_B includes a receiver PROD_B1 which receives modulating signals, a demodulation unit PROD_B2 which obtains coded data by demodulating the modulating signals received by the receiver PROD_B1, and a decoding unit PROD_B3 which obtains videos by decoding the coded data obtained by the demodulation unit PROD_B2. The above-mentioned image decoding apparatus 31 is utilized as the decoding unit PROD_B3.

The receiving apparatus PROD_B may further include a display PROD_B4 displaying videos, a recording medium PROD_B5 to record the videos, and an output terminal PROD_B6 to output videos outside, as supply destination of the videos output by the decoding unit PROD_B3. In FIG. 34B, although the configuration that the receiving apparatus PROD_B includes these all is exemplified, a part may be omitted.

Note that the recording medium PROD_B5 may record videos which are not coded, or may record videos which are coded in a coding scheme different from a coding scheme for transmission. In the latter case, a coding unit (not illustrated) to code videos acquired from the decoding unit PROD_B3 according to a coding scheme for recording may be interleaved between the decoding unit PROD_B3 and the recording medium PROD_B5.

Note that the transmission medium transmitting modulating signals may he wireless or may be wired. The transmission aspect to transmit modulating signals may be broadcasting (here, referred to as the transmission aspect where the transmission target is not specified beforehand) or may be telecommunication (here, referred to as the transmission aspect where the transmission target is specified beforehand), Thus, the transmission of the modulating signals may be realized by any of radio broadcasting, cable broadcasting, radio communication, and cable communication.

For example, broadcasting stations (broadcasting equipment, and the like)/receiving stations (television receivers, and the like) of digital terrestrial television broadcasting is an example of transmitting apparatus PROD_A/receiving apparatus PROD_B transmitting and/or receiving modulating signals in radio broadcasting. Broadcasting stations (broadcasting equipment, and the like)/receiving stations (television receivers, and the like) of cable television broadcasting are an example of transmitting apparatus PROD_A/receiving apparatus PROD_B transmitting and/or receiving modulating signals in cable broadcasting.

Servers (work stations, and the like)/clients (television receivers, personal computers, smartphones, and the like) for Video On Demand (VOD) services, video hosting services using the Internet and the like are an example of transmitting apparatus PROD_A/receiving apparatus PROD_B transmitting and/or receiving modulating signals in telecommunication (usually, either a radio or cable is used as transmission medium in the LAN, and cable is used for as transmission medium in the WAN). Here, personal computers include a desktop PC, a laptop type PC, and a graphics tablet type PC. Smartphones also include a multifunctional portable telephone terminal.

Note that a client of a video hosting service has a function to code a video imaged with a camera and upload the video to a server, in addition to a function to decode coded data downloaded from a server and to display on a display, Thus, a client of a video hosting service functions as both the transmitting apparatus PROD_A and the receiving apparatus PROD_B.

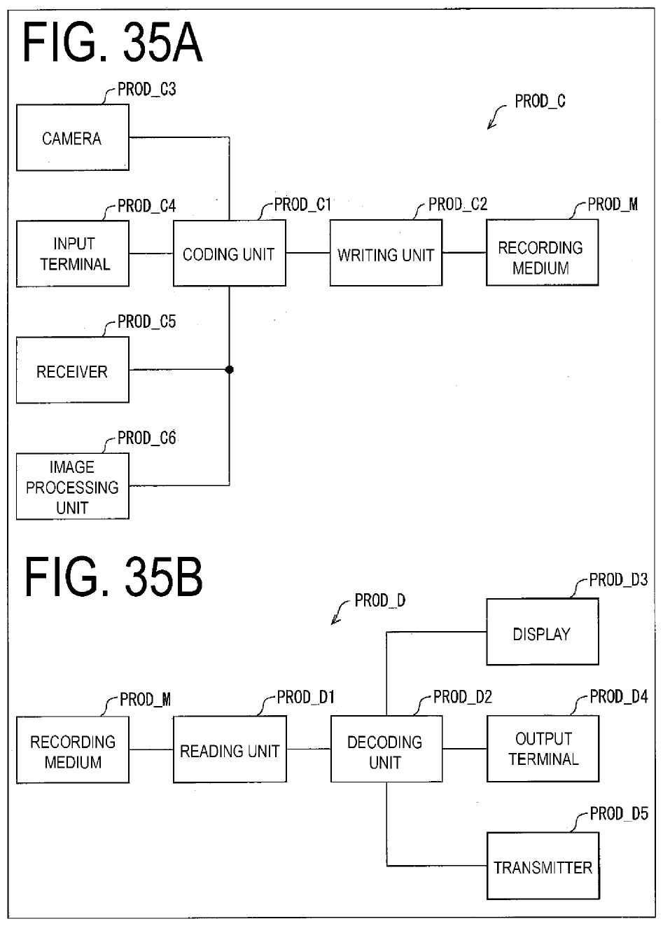

Next, referring to FIGS. 35A and 35B, it will be described that the above-mentioned image coding apparatus 11 and the image decoding apparatus 31 can be utilized for recording and regeneration of videos.

FIG. 35A is a block diagram illustrating a configuration of a recording apparatus PROD_C installed with the above-mentioned image coding apparatus 11. As illustrated in FIG. 35A, the recording apparatus PROD_C includes a coding unit PROD_C1 which obtains coded data by coding a video, and a writing unit PROD_C2 which writes the coded data obtained by the coding unit PROD_C1 in a recording medium PROD_M. The above-mentioned image coding apparatus 11 is utilized as the coding unit PROD_C1.

Note that the recording medium PROD_M may be (1) a type built in the recording apparatus PROD_C such as Hard Disk Drive (HDD) or Solid State Drive (SSD), may be (2) a type connected to the recording apparatus PROD_C such as an SD memory card or a Universal Serial Bus (USB) flash memory, and may be (3) a type loaded in a drive apparatus (not illustrated) built in the recording apparatus PROD_C such as Digital Versatile Disc (DVD) or Blu-ray Disc (BD: trade name).

The recording apparatus PROD_C may further include a camera PROD_C3 imaging a video, an input terminal PROD_C4 to input the video from the outside, a receiver PROD_C5 to receive the video, and an image processing unit PROD_C6 which generates or processes images, as sources of supply of the video input into the coding unit PROD_C1. In FIG. 35A, although the configuration that the recording apparatus PROD_C includes these all is exemplified, a part may be omitted.

Note that the receiver PROD_C5 may receive a video which is not coded, or may receive coded data coded in a coding scheme for transmission different from a coding scheme for recording, In the latter case, a decoding unit (not illustrated) for transmission to decode coded data coded in a coding scheme for transmission may be interleaved between the receiver PROD_C5 and the coding unit PROD_C1.

Examples of such recording apparatus PROD_C include a DVD recorder, a BD recorder, a Hard Disk Drive (HDD) recorder, and the like (in this case, the input terminal PROD_C4 or the receiver PROD_C5 is the main source of supply of a video). A camcorder (in this case, the camera PROD_C3 is the main source of supply of a video), a personal computer (in this case, the receiver PROD_C5 or the image processing unit C6 is the main source of supply of a video a smartphone (in this case, the camera PROD_C3 or the receiver PROD_C5 is the main source of supply of a video), or the like is an example of such recording apparatus PROD_C.

FIG. 35B is a block diagram illustrating a configuration of a regeneration apparatus PROD_D installed with the above-mentioned image decoding apparatus 31. As illustrated in FIG. 35B, the regeneration apparatus PROD_D includes a reading unit PROD_D1 which reads coded data written in the recording medium PROD_M, and a decoding unit PROD_D2 which obtains a video by decoding the coded data read by the reading unit PROD_D1. The above-mentioned image decoding apparatus 31 is utilized as the decoding unit PROD_D2.

Note that the recording medium PROD_M may be (1) a type built in the regeneration apparatus PROD_D such as HDD or SSD, may be (2) a type connected to the regeneration apparatus PROD_D such as an SD memory card or a USB flash memory, and may be (3) a type loaded in a drive apparatus (not illustrated) built in the regeneration apparatus PROD_D such as DVD or BD.

The regeneration apparatus PROD_D may further include a display PROD_D3 displaying a video, an output terminal PROD_D4 to output the video to the outside, and a transmitter PROD_D5 which transmits the video, as the supply destination of the video output by the decoding unit PROD_D2. In FIG. 35B, although the configuration that the regeneration apparatus PROD_D includes these all is exemplified, part of it may be omitted.

Note that the transmitter PROD_D5 may transmit a video which is not coded, or may transmit coded data coded in a coding scheme for transmission different than a coding scheme for recording. In the latter case, a coding unit (not illustrated) to code a video in a coding scheme for transmission may be interleaved between the decoding unit PROD_D2 and the transmitter PROD_D5.

Examples of such regeneration apparatus PROD_D include a DVD player, a BD player, an HDD player, and the like (in this case, the output terminal PROD_D4 to which a television receiver, and the like is connected is the main supply target of the video). A television receiver (in this case, the display PROD_D3 is the main supply target of the video), a digital signage (also referred to as an electronic signboard or an electronic bulletin board, and the like, the display PROD_D3 or the transmitter PROD_D5 is the main supply target of the video), a desktop PC (in this case, the output terminal PROD_D4 or the transmitter PROD_D5 is the main supply target of the video), a laptop type or graphics tablet type PC (in this case, the display PROD_D3 or the transmitter PROD_D5 is the main supply target of the video), a smartphone (in this case, the display PROD_D3 or the transmitter PROD_D5 is the main supply target of the video), or the like is an example of such regeneration apparatus PROD_D.

### Realization as Hardware and Realization as Software

Each block of the above-mentioned image decoding apparatus 31 and the image coding apparatus 11 may be realized as a hardware by a logical circuit formed on an integrated circuit (IC chip), or may be realized as a software using Central Processing Unit (CPU).

In the latter case, each apparatus includes a CPU performing a command of a program to implement each function, a Read Only Memory (ROM) stored in the program, a Random Access Memory (RAM) developing the program, and a storage apparatus (recording medium) such as a memory storing the program and various data, and the like. The purpose of the embodiments of the disclosure can be achieved by supplying, to each of the apparatuses, the recording medium recording readably the program code (execution form program, intermediate code program, source program) of the control program of each of the apparatuses which is a software implementing the above-mentioned functions with a computer, and reading and performing the program code that the computer (or a CPU or a MPU) records in the recording medium.

For example, as the recording medium, a tape such as a magnetic tape or a cassette tape, a disc including a magnetic disc such as a floppy (trade name) disk/a hard disks and an optical disc such as a Compact Disc Read-Only Memory (CD-ROM)/Magneto-Optical disc (MO disc)/Mini Disc (MD)/Digital Versatile Disc (DVD)/CD Recordable (CD-R)/Blu-ray Disc (trade name), a card such as an IC card (including a memory card)/an optical memory card, a semiconductor memory such as a mask ROM/Erasable Programmable Read-Only Memory (EPROM)/Electrically Erasable and Programmable Read-Only Memory (EEPROM: trade name)/a flash ROM, or a Logical circuits such as a Programmable logic device (PLD) or a field Programmable Gate Array (FPGA) can be used.

Each of the apparatuses is configured to be connectable with a communication network, and the program code may be supplied through the communication network. This communication network may be able to transmit a program code, and is not specifically limited. For example, the Internet, the intranet, the extranet, Local Area Network (LAN), Integrated Services Digital Network (ISDN), Value-Added Network (VAN), a Community Antenna television/Cable Television (CATV) communication network, Virtual Private Network, telephone network, a mobile communication network, satellite communication network, and the like are available. A transmission medium constituting this communication network may also be a medium which can transmit a program code, and is not limited to a particular configuration or a type. For example, a cable communication such as Institute of Electrical and Electronic Engineers (IEEE) 1394, a USB, a power line carrier, a cable TV line, a phone line, an Asymmetric Digital Subscriber Line (ADSL) line, and a radio communication such as infrared ray such as Infrared Data Association (IrDA) or a remote control, Bluetooth (trade name), IEEE 802.11 radio communication, High Data Rate (HDR), Near Field Communication (NFC), Digital Living Network Alliance (DLNA: trade name), a cellular telephone network, a satellite channel, a terrestrial digital broadcast network are available. Note that the embodiments of the disclosure can be also realized in the form of computer data signals embedded in a carrier wave where the program code is embodied by electronic transmission.

The embodiments of the disclosure are not limited to the above-mentioned embodiments, and various modifications are possible within the scope of the claims. Thus, embodiments obtained by combining technical means modified appropriately within the scope defined by claims are included in the technical scope of an aspect of the disclosure.

### CROSS-REFERENCE OF RELATED APPLICATION

This application claims the benefit of priority to JP 2016-244901 filed on Dec. 16, 2016, which is incorporated herein by reference in its entirety.

### INDUSTRIAL APPLICABILITY

The embodiments of the disclosure can be preferably applied to an image decoding apparatus to decode coded data where graphics data is coded, and an image coding apparatus to generate coded data where graphics data is coded. The embodiments of the disclosure can be preferably applied to a data structure of coded data generated by the image coding apparatus and referred to by the image decoding apparatus.

### REFERENCE SIGNS LIST

11 IMAGE CODING APPARATUS (VIDEO CODING APPARATUS)
112 INTER PREDICTION PARAMETER CODING UNIT (PREDICTION PARA METER DERIVING UNIT)
31 IMAGE DECODING APPARATUS (VIDEO DECODING APPARATUS)
INTER PREDICTION PARAMETER DECODING UNIT (MOTION VECTOR DERIVING UNIT)
3031 INTER PREDICTION PARAMETER DECODING CONTROL UNIT (MOTION VECTOR DERIVING UNIT)

1. A video decoding apparatus, comprising:
a decoding unit configured to:
decode, from coded data of a slice header, an MV signaling mode indicative of an accuracy of a difference vector;
decode a motion vector flag from the coded data for each block; and
decode a sign of a difference motion vector from the coded data; and
a motion vector deriving unit configured to derive a motion vector of the block on the basis of a sum of the difference vector and a prediction vector, wherein
the motion vector deriving unit derives an absolute value of the difference vector on the basis of the MV signaling mode and the motion vector flag and derives the difference vector from the absolute value of the difference vector and a sign of the motion vector.

2. A video decoding apparatus that generates a prediction image for each block by performing motion compensation on a target image, the video decoding apparatus comprising:
a decoding unit configured to decode a magnitude and a sign of a first difference motion vector from coded data; and
a motion vector deriving unit configured to derive a motion vector of the block on the basis of a sum of a second difference vector and a prediction vector, wherein
the motion vector deriving unit derives the second difference vector by shifting the first difference vector by using a shift amount corresponding to a position of the block in the target image.

3. The video decoding apparatus according to claim 2, wherein the shift amount is larger in a case that the block is positioned between a first predetermined position and a second predetermined position among vertical coordinates of the target image than in a case that the block is not positioned between the first predetermined position and the second predetermined position among the vertical coordinates of the target image.

4. The video decoding apparatus according to claim 2, wherein
the target image is an image in which an image on a spherical surface is projected onto each surface of a cube, and
the motion vector deriving unit derives a shift amount corresponding to a distance between a position of the block and a center position in the image in which the image on the spherical surface is projected onto each surface of the cube.

5. A video coding apparatus, comprising:
a motion vector deriving unit configured to derive a difference vector from a motion vector and a prediction vector of a block; and
a coding unit configured to code, with use of a slice header, (i) an MV signaling mode indicative of an accuracy of the difference vector, (ii) a motion vector flag, and (iii) a sign of a difference motion vector, wherein
the motion vector deriving unit derives an absolute value and a sign of the difference vector on the basis of the MV signaling mode and the motion vector flag.

6-17. (canceled)
